(19) United States
(12) Patent Application Publication
(10) Pub. No.: US 2019/0122234 A1
(43) Pub. Date: Apr. 25, 2019

(54) VERIFYING AND AUTHORIZING WORK

(71) Applicant: Matt McDermott, Cave Creek, AZ (US)

(72) Inventor: Matt McDermott, Cave Creek, AZ (US)

(21) Appl. No.: 16/228,086

(22) Filed: Dec. 20, 2018

Related U.S. Application Data
(63) Continuation of application No. 16/033,137, filed on Jul. 11, 2018.
Application No. 16/033,137 is a continuation of application No. 15/812,764, filed on Nov. 14, 2017, now abandoned.
Application No. 15/812,764 is a continuation of application No. 14/934,771, filed on Nov. 6, 2015, now abandoned.
(60) Provisional application No. 62/076,447, filed on Nov. 6, 2014.
(60) Provisional application No. 62/076,458, filed on Nov. 6, 2014.
(60) Provisional application No. 62/076,446, filed on Nov. 6, 2014.
(60) Provisional application No. 62/076,453, filed on Nov. 6, 2014.
(60) Provisional application No. 62/076,442, filed on Nov. 6, 2014.

(51) Int. Cl. G06Q 30/02; H04L 29/06; G06Q 30/00

(52) U.S. Cl. CPC G06Q 30/0201; H04L 63/10; G06F 2221/2113; H04L 63/08; G06Q 30/016

(57) ABSTRACT

A method or system according to the present disclosure may be used to convey information to enhance customer service. Among other things, methods and systems of the present disclosure allow a service provider to supply customers with information on suggested services in a manner that is efficient, and easy to access. The information can be distributed in a variety of formats and be stored permanently or temporarily.

### CROSS REFERENCE TO RELATED APPLICATIONS

This application is a continuation of U.S. patent application Ser. No. 16/033,137 entitled “VERIFYING AND AUTHORIZING WORK,” filed Jul. 11, 2018, which is a continuation of and claims priority to U.S. patent application Ser. No. 15/812,764 filed on Nov. 14, 2017, entitled “VERIFYING AND AUTHORIZING WORK,” which claims priority to U.S. patent application Ser. No. 14/934,771 filed on Nov. 6, 2015 entitled “VERIFYING AND AUTHORIZING WORK,” which claims priority to U.S. Provisional Patent Application No. 62/076,442 filed Nov. 6, 2014 entitled “METHOD AND SYSTEM FOR REVIEWING AND APPROVING WORK,” U.S. Provisional Patent Application No. 62/076,446 filed Nov. 6, 2014 entitled “DEVICE FOR VEHICLE MAINTENANCE AND REPAIR,” U.S. Provisional Patent Application No. 62/076,447 filed Nov. 6, 2014 entitled “VEHICLE REPAIR MAINTENANCE SYSTEM AND METHOD,” U.S. Provisional Patent Application No. 62/076,453 filed Nov. 6, 2014 entitled “VEHICLE REPAIR SYSTEM AND METHOD,” and U.S. Provisional Patent Application No. 62/076,458 filed Nov. 6, 2014 entitled “VEHICLE REPAIR SYSTEM AND METHOD,” the respective disclosures of each of which are incorporated herein by reference.

### FIELD OF DISCLOSURE

The present disclosure relates to systems and methods for providing information relating to proposed work. More particularly, the disclosure relates to systems and methods for providing audio and/or video information relating to proposed services and for reviewing and following up regarding the proposed services.

### BACKGROUND OF THE DISCLOSURE

For many businesses, particularly those in service-based industries, a lack of communication between the customer and the business can be the greatest obstacle to a positive experience for the customer. Customers who feel uninformed about the service a business provides may walk away feeling frustrated, confused, that they were overcharged, or that they did not receive everything promised to them. Such negative experiences can drive customers away.

An increasing number of websites and blogs on the Internet dedicated to consumer affairs and product reviews are providing individuals with the ability to relate their experiences to a wide audience. Through these sites, a negative review by a single unhappy customer can influence many potential customers to avoid a product or service provided by a business. Accordingly, the importance of providing exemplary customer service to help ensure happy, loyal customers has never been greater.

In the automotive industry, for example, technicians or mechanics frequently perform services, such as repairs and diagnostic procedures on vehicles, without ever speaking directly to the owner of the vehicle. Even when a customer is able to speak directly to a mechanic who performs the service on his/her vehicle, the customer may still not fully understand the full extent of the service due to its complexity (and the complexity of the terminology used to describe it), or be able to remember everything they were told hours or days later (e.g., when a family member asks about the service). Similar issues exist in other industries (such as law, medicine, and insurance), where a customer's understanding of (and satisfaction with) a service is largely dependent upon the service provider's ability to communicate complex information to the customer. The present disclosure addresses these and other issues.

### SUMMARY OF THE DISCLOSURE

Methods and systems according to the present disclosure may be used for a variety of applications, including conveying information to enhance customer service in a wide variety of industries. Among other things, systems and methods of the present disclosure allow a service provider to provide a customer with information regarding proposed services for the customer in a manner that is efficient and easy for a customer to access. Exemplary systems and methods also allow service providers to gather metrics on communications to customers, as well as to facilitate targeted marketing efforts to help build customer loyalty.

In accordance with various embodiments of the disclosure, a system for facilitating review of proposed services includes a network, a first device having a provider application, and a second device having a customer application. The first device can be used by, for example, a technician, mechanic, and/or service advisor. The second device can be used by, for example, a consumer or a warranty provider. In accordance with various aspects of these embodiments, the provider application allows a user to capture information (e.g., video) documenting proposed services to be provided. In accordance with further aspects, the customer application displays information (e.g., video) regarding the proposed services. The customer can use the application to contact the user in response to the proposed services, to directly approve of the proposed services, and/or to pay for the proposed services. A streaming server including a streaming server application may be coupled to the network. The streaming server application is configured to identify one or more of a device type and an operating system. The streaming server application could select a format for compression of the information based on the device type and/or operating system. This allows rapid streaming of the information, while providing suitable resolution of the information. A notification may be sent from the consumer application to the provider application when the information has been displayed or reviewed on the second device. A notification may also be sent to the consumer application when the information is ready to be viewed. The consumer application can automatically start running when a notification is received by the consumer application. The system may further include a second server, such as a web services server. Customer information, such as account log-in information, vehicle identification number(s), and other information can be stored within a database that can be associated with or coupled to the second server.

Exemplary servers suitable for various embodiments of the present disclosure include a communications interface, a processor coupled to the communications interface, and a memory coupled to the processor. The memory stores instructions that, when executed by the processor, cause the processor to establish a connection with a device using the communications interface and receive data from a device through the communications interface. The memory further stores instructions to cause the processor to create a file that comprises data received from a device, as well as to create an entry in a database, the entry comprising reference information pertaining to the file.

In accordance with exemplary embodiments of the disclosure, a method for reviewing proposed services includes storing customer information in a database (which may form part of, for example, a server, such as a web services server), using a first device, capturing information (e.g., video and/or audio) regarding the proposed services, streaming the information regarding the proposed services to a streaming server, using the streaming server, compressing the information regarding the proposed services, and sending the compressed information regarding the proposed services to a second device. The stored data can include, for example, a customer name, a vehicle identification number (VIN), a customer ID (e.g., an email address), and prior service history associated with the VIN and/or customer ID. The information is preferably compressed in real-time. The streaming server may include a streaming server application that determines a type of second device and/or an operating system of the second device and formats the compressed information based on the determined operating system and/or device type.

Exemplary methods and systems described herein can also create and use analytics for a variety of applications and/or generate ads or coupons and/or send ads or coupons to the first device based on, for example, analytics and/or services history, type of vehicle, age of vehicle, and the like.

Both the foregoing summary and the following detailed description are exemplary and explanatory only and are not restrictive of the invention.

### BRIEF DESCRIPTION OF THE DRAWING FIGURES

FIG. 1 illustrates a system in accordance with exemplary embodiments of the disclosure.

FIG. 2 illustrates a method in accordance with further exemplary embodiments of the disclosure.

FIG. 3 illustrates a user interface of a device having an application in accordance with exemplary embodiments of the disclosure.

FIGS. 4-8 illustrate exemplary user interfaces in accordance with further exemplary embodiments of the disclosure.

FIGS. 9A-12A-L illustrate another method in accordance with further exemplary embodiments of the disclosure.

FIGS. 13A-14 illustrate exemplary features of systems and methods of the disclosure.

### DETAILED DESCRIPTION OF EXEMPLARY EMBODIMENTS OF THE DISCLOSURE

The description of various embodiments of the present disclosure provided below is merely exemplary and is intended for purposes of illustration only; the following description is not intended to limit the scope of an invention disclosed herein. Moreover, recitation of multiple embodiments having stated features is not intended to exclude other embodiments having additional features or other embodiments incorporating different combinations of the stated features.

Exemplary methods and systems of the disclosure can be used for a variety of applications. For convenience, the exemplary methods and systems are described in connection with recommending car repair services. However, unless otherwise noted, the invention is not limited to such applications.

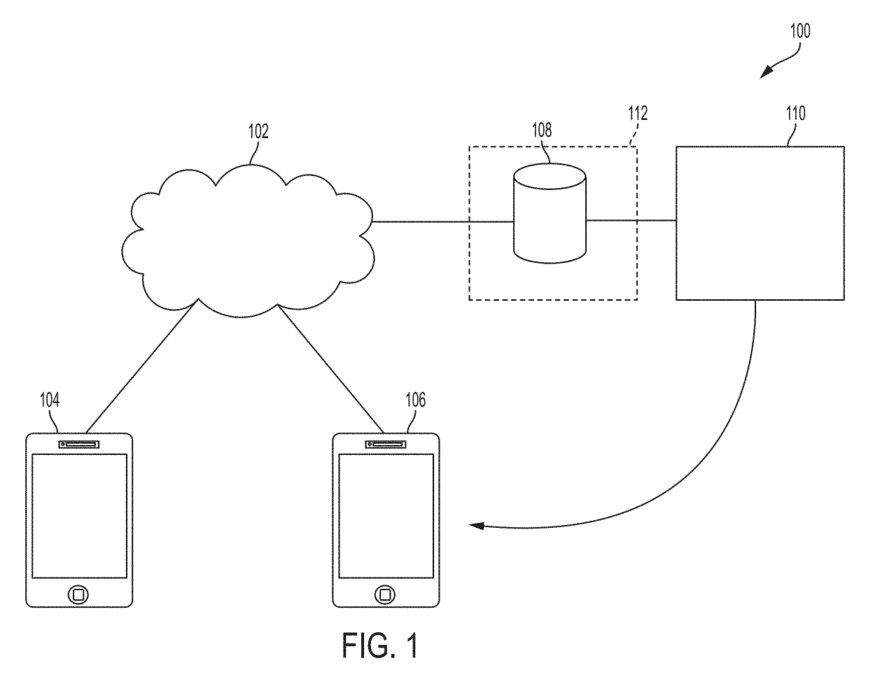

FIG. 1 illustrates a system 100 in accordance with various embodiments of the disclosure. System 100 includes a network 102, a first device 104, a second device 106, a database 108, a streaming server 110, and optionally a web services server 112 (which can include database 108). Although illustrated with a network 102, two devices 104, 106, two servers 110, 112, and one database 108, exemplary systems can include any suitable number of networks, devices, servers, and databases.

As set forth in more detail below, by way of examples, video and/or audio information regarding proposed services can be captured using device 104. Once a user of device 104 indicates the captured information is acceptable, the captured information is sent to database 108, where it is stored along with vehicle identification and/or user information, and also sent to server 110, either directly or via server 112 or database 108. Server 110 compresses the information and sends the compressed information to second device 106. In accordance with various aspects of these examples, server 110 includes a page profile, which is used to determine an operating system and/or type of device 106, so that the compressed information will be in an appropriate format for viewing on device 106. In accordance with further aspects, a notification is sent to device 104 once the compressed information is viewed on device 106.

Network 102 can include a local area network (LAN), a wide area network, a personal area network, a campus area network, a metropolitan area network, a global area network, the Internet, or the like. Network 102 can be coupled to one or more devices 104, 106 using an Ethernet connection, other wired connections, wireless interfaces, such as Bluetooth, Wifi, or mobile communication protocols, such as wireless application protocol (WAP), or the like. Network 102 can be coupled to other networks and/or to other devices.

In the illustrated example, user devices 104, 106 are conveniently illustrated as mobile devices. However, devices 104, 106 can be any suitable device, including a laptop computer, a desktop computer, a mobile subscriber communication device, a mobile phone, a personal digital assistant (PDA), and/or a data tablet, having a suitable application (namely, a provider application (also referred to herein as a first application) and/or a customer or second application). Such devices can include any suitable user interface components to allow a user to input data, such as a keyboard, mouse, touch pad, touch screen, alphanumeric keypad, voice recognition system, and/or other input device. Similarly, devices 104, 106 can include any number of suitable output devices, such as a monitor, speaker, printer, or other device. Devices 104, 106 can also include software to allow a user to connect to the server 110 and/or 112, select various user interface components (such as a microphone or camera) to provide data to the server 110 and/or 112, access a file or database entry stored on the server 110 and/or 112 or database 108, or perform any other suitable function in accordance with the present disclosure.

Device 104 includes a first or provider application that is used by a user associated with the provision of services. The provider application includes a user interface to allow a user, such as a technician, mechanic, or service advisor, to capture video and/or audio recordings and have the recordings streamed to a second device. In accordance with various aspects of these embodiments, the user interface includes options to indicate a type of service, e.g., brake repair, tire repair, engine repair, etc., or “other,” to capture (e.g., input or video capture a vehicle identification number), and/or to capture any notations, such as the reason a vehicle was brought in for service. In accordance with various aspects of these exemplary embodiments, a user selects a video capture button on the user interface to begin capturing video. At this time, a light on device 104 may automatically illuminate to provide a better quality of captured video.

Device 106 includes a second or customer application. The customer application receives compressed streaming video and/or audio information from streaming server 110. In accordance with exemplary embodiments, the customer application receives a notification (e.g., from streaming server 110, web services server 112, and/or device 104) when streaming media is available for review. The notification may be provided to a recipient in any desired manner. For example, embodiments of the present disclosure may provide the file (or access to the file) in an SMS text message, MMS multimedia message, a voice mail message, an email message, and/or using any other desired form of communication. The communication may include any desired information. For example, the communication may include content that is selected based on identification information for the recipient, such as a personalized greeting, the recipient's name, and other content related to the recipient. Additionally, the communication may include content based on data in the file, such as an identification of the service provided to the recipient. In one exemplary embodiment of the present disclosure, an email is provided to a customer regarding a repair performed on the customer's vehicle.

By way of example, the notification can be sent from device 104 to web services server 112 to device 106 using network 102. Once a user receives a notification on device 106, the customer application can be automatically opened using device 106. Alternatively, the user can access the notification and perform a gesture (e.g., a swipe or a push of a button) to active the application. The customer application can be further configured to receive customer application log-in information and can store the customer application log-in information. This allows a user to only log in once for each device used to review information.

The information received on device 106 can be cached, and the cached information can be cleared once the customer application is closed. Thus, very little memory of device 106 is used to run the customer application.

Exemplary servers 110, 112 include a processor (not shown) and a memory (not shown). The processor can retrieve and execute instructions stored in the memory to control the operation of the server, including communication with the database 108 and one or more devices 102, 104. Servers 110, 112 may include or operate in conjunction with any type (and number) of computers, computer systems, computer networks, computer workstations, minicomputers, mainframe computers, or computer processors (such as an integrated circuit microprocessor or microcontroller). Servers 110, 112 may include an operating system (e.g., Windows NT, 95/98/2000/XP/Vista, OS2, UNIX, Linux, Solaris, MacOS) as well as various conventional support software and drivers typically associated with computers. In certain embodiments, dedicated data management applications may be entirely or partially served or executed by server 110 and/or 112 in performing methods or processes in accordance with various examples of the disclosure. Server 110 may also be configured as a web server to host any number of Internet websites, as well as an email server with multiple domains.

A memory operating in conjunction with the server 110 and/or 112 may include any combination of different memory storage devices, such as hard drives, storage area networks (SANs) (e.g., disk arrays, tape libraries, optical jukeboxes), networked attached storage (NAS), NAS-SAN hybrid systems, random access memory (RAM), read only memory (ROM), FLASH memory, or any other type of volatile and/or nonvolatile memory. Systems and methods of the present disclosure may also store and retrieve data from one or more databases 108.

Servers 110, 112 may communicate with one or more devices or each other using any desired connection. In one embodiment of the present disclosure, servers 110 and/or 112 include a wireless transceiver to communicate with other systems and devices through a wireless system such as a wireless mobile telephony network, General Packet Radio Service (GPRS) network, wireless Local Area Network (WLAN), Global System for Mobile Communications (GSM) network, Personal Communication Service (PCS) network, Advanced Mobile Phone System (AMPS) network, and/or a satellite communication network and/or Code Division Multiple Access (CDMA). Servers 110, 112 operating in accordance with exemplary embodiments of the disclosure may also communicate with other systems and devices through any other type of connection, such as a wired Internet connection, a wireless Internet connection, a Powerline Network, a cellular telephone network connection, a wireless LAN connection, a wireless WAN connection, a mobile device synchronization port connection, a power connection, a serial peripheral interface bus (SPI) connection, a universal serial bus (USB) connection, an RS-232 serial connection, an Ethernet connection, an optical fiber connection, a Firewire connection and/or a security cable. Data from a device may be received using any number and combination of such connections, as well as any other type of connection. Additionally, servers 110, 112 may communicate with a device using any suitable data format and communications protocol. A server operating in conjunction with the present disclosure can also be configured to implement an Interactive Voice Response (IVR) system, and/or to recognize DTMF tones, in order to receive data from a human data source, such as an individual providing information through a telephone.

Data received from a device may be in any format, such as audio, video, text, and one or more still images. For example, embodiments of the present disclosure may receive information in a data packet, an SMS text message, MMS message, a voice mail message, an email message, and/or a predetermined sequence of one or more DTMF tones. The data can be included in a file having a tokenized format such as standard ASCII text format, or any other suitable standardized file format, such as an MS Word document, MS Excel file, Adobe PDF file, or binary picture file (JPEG, bitmap, etc.). The data within such a file can be ordered in any manner and have any suitable delimiters, notations, or other features.

In accordance with various exemplary embodiments, server 110 and/or 112 creates a file using the data received from one or more device 104, 106. The file may be of any format, and may include data of differing formats, such as text, audio, video, and/or still images. In one embodiment of the present disclosure, the file is in MPEG4 format. The file may be created in any desired manner. For example, the file may be created once all data to be added to the file has been received from one or more devices. The file may also be created in real-time by adding data to the file as it is received from the device. The file may be stored in a memory device (such as a hard drive) in communication with server 112, or in a database 108. The file may be stored locally to the server 110 and/or 112 or stored remotely from the server, such as in a secure data storage facility.

Any type of information may be received from a device and included in the file created by the server 110 and/or 112, such as data pertaining to a service provided for a customer. In one embodiment of the present disclosure, for example, data pertaining to a repair performed on a vehicle by a service provider (such as a car dealership) may include a vehicle identifier, a customer identifier, a user identifier (e.g., an identifier for a mechanic who performed the service or for a service manager), an identifier for the service provider (e.g., dealership or repair center) at which the repair was performed, a repair order identifier, and/or information regarding the repair performed on the vehicle stored on server 112 and/or database 108.

In accordance with the present disclosure, the file can include audio, video, still images, and/or text showing the repair being performed or other information regarding the repair. In one exemplary embodiment, a computer having a searchable database stores such a file reference in the database. The file can be located in the database by searching one or more fields, such as the vehicle identification number (VIN) of an automobile, the name of the person and/or entity who created the file, the make, model and year of manufacture of the automobile, the date the file was created, the date the file was stored in the searchable database, and/or the type of problem addressed in the file (e.g., the repair procedure that was performed on the vehicle).

The file may additionally include audio, video, text or pictures of the faulty/broken parts removed from the vehicle, new parts that were installed in a vehicle, and/or maintenance or repairs suggested by the service provider. The file can also show the location where the parts reside in the vehicle to, for example, educate the customer and help explain the amount of labor involved in replacing a part that is difficult to access.

In one exemplary embodiment, the file is created real-time as data is received from a device connected to server 110 and/or 112, such as a user (e.g., the technician performing the repair) providing input to a microphone, camera, or other receiver connected to or integrated with a device. The audio and/or video data from the device is provided to, for example, server 110, and is stored in the file in the database 108.

An entry in the database 108 is created with reference information (also known as fields) pertaining to the file to facilitate the storage and retrieval of the file using the reference information. The database entry may be separate from, linked to, or integrated with, the file. The database entry may be created using a database having any desired database implementation, such as a hierarchal database, relational database, and/or network database. The file may be searched for, accessed, and retrieved by server 112, or by using any device capable of communication with server 112, such as devices 104, 106. Access to the file may be protected using any desired security requirement, such as those described herein. Among other things, the reference information for the database entry allows the file to be indexed and/or searched for according to a variety of fields, such as the creation date of the file, the identity of the user who created the file, the content of the file (e.g., a particular type of service), or any other suitable fields. Some or all of the fields may be automatically populated when the file is created and/or manually populated (e.g., by the user who created the file). The fields of the database entry may be added, removed, or modified after the file is created as well.

In accordance with exemplary embodiments of the disclosure, streaming server 110 receives video information from database 108 and/or device 104, compresses and/or encodes and/or transcodes the information (e.g., in real-time when required), and streams the compressed information to device 106. An exemplary streaming server includes a profile page to allow streaming server 110 to determine a type and/or operating system of device 106. This allows streaming server 110 to format the compressed information based on the operating system and/or type of device 106.

In one exemplary embodiment of the present disclosure, data is streamed to and from the server 110 (e.g., between server 110 and server 112) using a Real Time Messaging Protocol (RTMP) protocol from Adobe Systems, Inc., and/or HTTP Live Streaming (HLS) protocol and/or Real Time Streaming Protocol (RTMP), which provides a socket connection for two-way communication between devices and the server 110. Using any of these protocols, the server 110 can create files in real-time from data streamed to the server 110 by devices (e.g., devices 104, 106). Through the RTMP connection, the server 110 also allows users to view the created files, as is discussed in more detail below.

Database 108 receives information from device 104 and stores the information. For example, database 108 can receive user information, such as a user id (e.g., an email address), a vehicle identification number, contact information, past repair history for vehicles and/or for a particular vehicle, and the like. By way of example, database 108 stores vehicle identification information and associated repair information, e.g., past suggested repairs, past repairs completed, and the like. Database 108 can include any video and/or audio information captured using, for example, device 104. Data from database 108 can be retrieved and viewed by either device 104 or 106.

Database 108, in accordance with exemplary embodiments of the present disclosure may be implemented as a database management system (DBMS), a relational database management system (e.g., DB2, Oracle, SQL Server, My SQL, ACCESS, etc.), an object-oriented database management system (ODBMS), a file system, or in any another manner. Database 108 can be accessed by the server 110 and/or server 112 via a Structure Query Language (SQL) or in any other desired manner. Database 108 may be organized in any suitable manner, including as data tables or lookup tables. Association of certain data may be accomplished through any desired data association technique and data association may be accomplished manually and/or automatically. In one embodiment, database 108 is configured to store information related to a service performed for a customer. Information from database 108 may be used by the service provider to provide customer service, build customer loyalty, and/or facilitate targeted marketing efforts, as is described in more detail below.

The customer's service history (and associated files) may include all services performed on any vehicle currently owned by the customer, as well as all services performed for the customer on any vehicle, whether or not the customer currently owns the vehicle. In one embodiment of the present disclosure, for example, the service history of a vehicle is removed from a customer's overall service history when the customer no longer owns the vehicle. The service history for the vehicle may then be transferred to the service history for the purchaser of the vehicle. Alternatively, users of systems and methods of the present disclosure may access the service history of a vehicle independent of the current owner of the vehicle. Among other things, allowing alternate identifiers (such as a VIN of a vehicle) to access service histories and files helps ensure that records can be retrieved even when ownership of a vehicle has been transferred or is unknown.

The file and/or database 108 information can be analyzed to determine one or more metrics. Such metrics may pertain to the creation of the file, retrieval of the file, the providing of the communication to the recipient, or any other aspect of the present disclosure. For example, in one embodiment of the present disclosure where the file includes information pertaining to a repair service for a vehicle, the metric may include a repair history for a vehicle, contact information for a customer, marketing information, a status of a repair procedure for a vehicle, and any combinations thereof. The analysis and determining of metrics may be performed automatically by the server 112, or in response to a command from a user of the server 112. Metrics may be stored (e.g., in a memory device or the database 108) for retrieval by a user of the server 112. Access to stored metrics can be restricted based on a predefined security requirement, such as those discussed herein. Among other things, the metrics can allow a user to review, gather statistics, and/or generate reports pertaining to the current and past operation of systems and methods of the present disclosure in order to verify that a desired level of information is being provided to customers.

A file may be modified at any time and in any manner. Modification of a file may include the addition, as well as the deletion, of any desired content, such as audio, video, text, and still images. Content can be added to, or deleted from, any portion of the file. The file may be modified manually by a user, as well as automatically by the server 112. In one exemplary embodiment of the present disclosure, a file containing data pertaining to a vehicle repair, and created by a technician performing the repair, can be reviewed by a supervisor or service advisor (e.g., from the service department or sales department of the service provider where the vehicle was serviced), provided a predefined security requirement (such as those described herein) has been met. The supervisor or other user can remove or correct any erroneous or undesirable content in the file, as well as add new content (such as a customized or personalized greeting to the customer(s) the file will be sent to). Server 112 may also automatically modify any desired portion of the file.

An exemplary web services server 112 includes an application programming interface (API). The API can receive information from device 104 and web services server 112 transmission of information to device 106 in response to information received from device 104. For example, web services server 112 can receive a notification from device 104 that video and/or audio information has been captured and is ready to be reviewed by a customer using device 106.

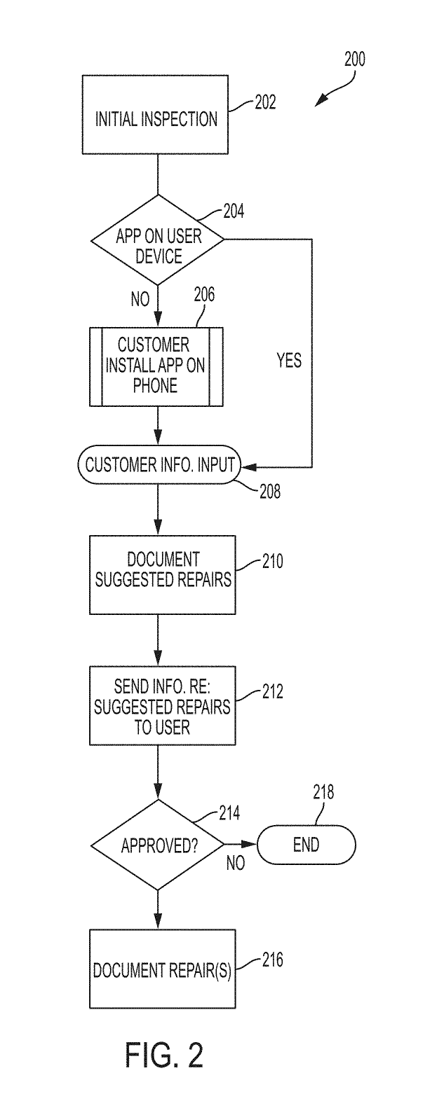

Turning now to FIG. 2, an exemplary method 200 is illustrated. Method 200 includes the steps of performing an initial inspection (step 202), determining whether a suitable application is on a device (step 204) and if not, installing the application (step 206), inputting customer information (step 208), documenting suggested services (step 210), sending suggested repair information to a user (step 212), determining whether services have been approved (step 214), and if so, documenting (e.g., completed) repairs, and if not, ending the process (step 218).

Prior to or during step 202, a service provider (e.g., a service advisor) can log into the service provider application. By way of example, during a service provider login process, a server (e.g., server 112) can verify that the Internet Protocol (IP) address used by the service provider member's device corresponds to an expected address, to prevent unauthorized use. Additionally, the service provider can enter a valid username, password, and service provider identifier to successfully login. If the username, password, or identifier is incorrect, the service provider member may retry entry, or may be locked out entirely if too many incorrect attempts are made. Upon successful login, one or more of the service provider member's username, password, service provider ID, role of the user (e.g., administrator, cashier, manager, director, advisor, or technician), and privileges of the user are noted by the software operating on the server. Users having different roles and/or privileges may thus be restricted from performing different functions on the server.

During step 202, a user (e.g., server provider) uses a device (e.g., device 104) to document repairs that a customer would like to have done and/or that a service provider recommends. During this step, the service provider uses a device (e.g., device 104) to video record an image of a vehicle, which may include capturing a vehicle identification number, such as a VIN. The device can be used to video record any desired repairs, as well as the customer's description of problems and/or desired repairs. In accordance with exemplary aspects of these embodiments, a provider application on the device can automatically recognize and capture the VIN. In accordance with further aspects, the provider application converts audio to text to document notes associated with repair work.

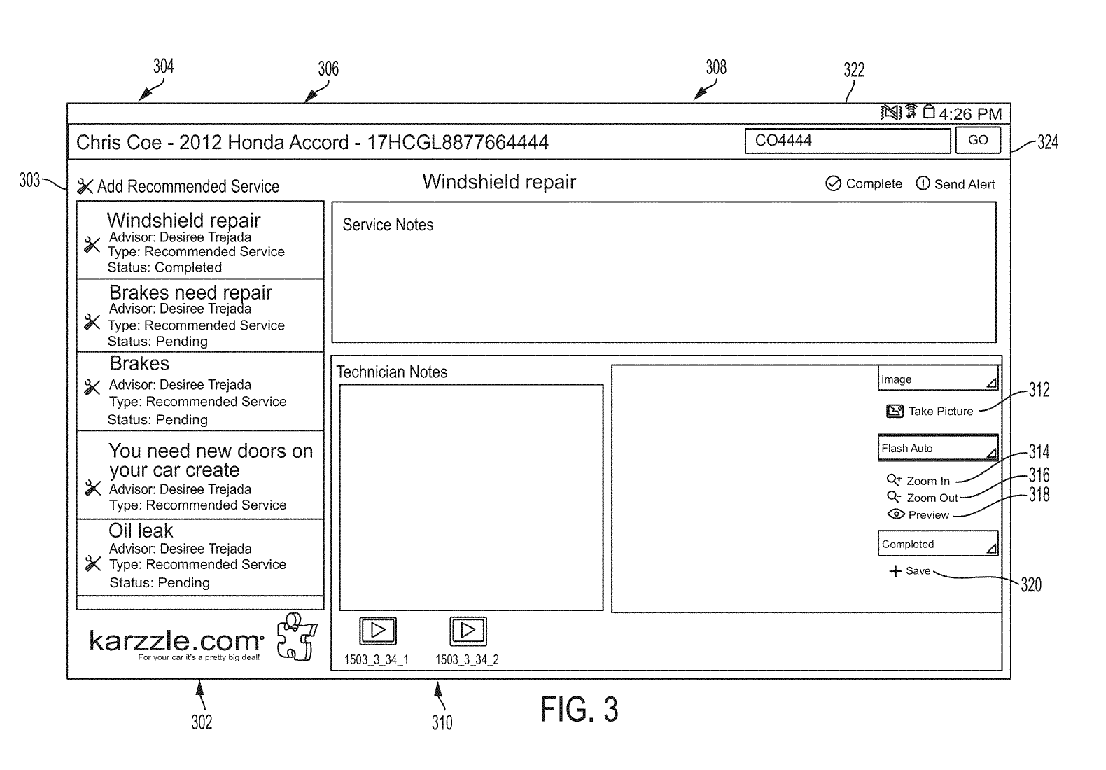

FIG. 3 illustrates a user interface 300 on a service provider's device. User interface 300 includes information regarding suggested repairs 302, a button 303 to allow a service provider to add a suggested repair, customer identification information 304, vehicle identification information 306, an area for service notes 308, video icons relating to a selected recommended service 310, a button to allow a user to take a picture 312, zoom in and zoom out button 314, 316, a preview button 318 to allow a user to preview any recorded video or audio information, a save button 320, a complete button 322, and a send alert button 324. In accordance with some exemplary aspects of these embodiments, once a user selects the complete button, information regarding the customer, the vehicle identification, the captured video and/or audio is sent to a web services server, such as server 112. At the same time the video information can be sent to streaming server 110 for real-time compression and formatting of the information. Send alert button 324 can be used to send an alert to a customer's device (e.g., device 106) to notify the customer that information regarding repair work is ready to be reviewed and/or send an alert to the advisor to notify of status of repair and/or notes on repair and/or pricing.

During this step, a user can press a stop button or pause button to stop or pause the recording, and can use the play button 310 to play (and thereby review) the file containing the audio and/or video recorded to the file. The user can use the replay button 310 to replay the file from the beginning. A mode and time indicator can show the elapsed time of the recording, as well as any appropriate mode indicator (e.g., ready to record). A status bar can convey information such as the current service invoice number, an identifier for the service provider (e.g., dealership or repair center) where the repair is performed, an identifier for the user, the type of input device(s) (e.g., a microphone and/or camera) used to record the data, as well as any other desired information. To save storage space on the server 112, database 108, and/or other storage medium (such as a storage area network in communication with the server 112), files and database records can be archived. Archiving can be performed based on any desired criteria, such as the current storage capacity of the server 112, as well as the age of a file or database record. The database record can be updated to point to the new archived location of a file, allowing users to continue to access the file.

A user may add, delete, modify, or record over data previously recorded to a file, provided the user satisfies any appropriate security requirements. A user's ability to record over data, or otherwise modify a file, may be dependent on any number of desired criteria, such as a privilege level of the user and/or whether the communication providing the file has already been sent to the customer. The user may record over any desired subject matter recorded to the file by, for example, selecting a desired point in a previously-recorded portion of audio and/or video and re-recording from that point. Alternatively, a user may selectively edit, rearrange, or modify recorded audio and/or video using any desired method, such as commercially-available editing software or annotate with the stylus. A user may modify a file using data from any suitable source.

During step 204, a determination is made whether a customer has the customer application on a device. If no, then the customer can be instructed how to download the application onto his or her device. Once the application is on the customer device, method 200 proceeds to step 208.

During step 208, a user (e.g., customer) may log in to satisfy security requirements and to establish a connection between a server (e.g., server 112) and a customer device (e.g., device 106). When the connection (e.g., an RTMP) connection is established, the server can receive data through a device. Video of the service, vehicle, replaced parts, or other subject matter can be described by the user and streamed (i.e., transmitted as it is recorded) to the server 110.

For the login of a customer, a customer can enter a username and password. The username and password (as well as a link to a website hosted on the server (e.g., server 112) having the login screen) may be provided to the customer in a communication. If the username and/or password is incorrect, the customer may retry entry, or may be locked out entirely if too many incorrect attempts are made. Upon successful entry of the username and password, the customer's identification is noted and the customer is given access to his/her service history, as well as access to the file(s) in the customer's service history. In accordance with various aspects, a user may only need to sign in once for a given device.

At step 210, a user, e.g., a technician, mechanic, or service advisor, uses a device (e.g., device 104) to document suggested repairs. The suggested repairs can include repairs requested by a customer and/or repairs suggested by the service advisor, technician, or mechanic. In an exemplary method, a connection with a device is established, provided any predefined security requirements are satisfied. Systems and methods of the present disclosure may utilize one or more security requirements to protect data, restrict access, or provide any other desired security feature. For example, a computer system (such as the server 112) may encrypt data transmitted to it from, for example, devices 104, 106, and/or may encrypt some or all data stored within the server itself or in database 108. Different users and devices may also have different security requirements and/or different levels of access to data stored by the server 112 or database 108. Such security measures may be implemented using hardware, software, or a combination thereof. Any method of data encryption or protection may be utilized in conjunction with the present disclosure, such as public/private keyed encryption systems, data scrambling methods, hardware and software firewalls, tamper-resistant or tamper-responsive memory storage devices or any other method or technique for protecting data. Similarly, passwords, biometrics, access cards or other hardware, or any other system, device, and/or method may be employed to restrict access to any device operating in conjunction with the present disclosure.

At step 212, information is transmitted to a customer using a streaming server, such as server 110.

During step 214, a customer reviews information streamed from a streaming server. The information can be formatted based on the customer's device types and compressed based on a bandwidth available for data transmission. If a customer desires the service, the customer can be presented with an option to call the service provider (e.g., a service advisor, technician, or mechanic), an option to approve the service, and/or an option to pay for the service.

During step 216, if the repair work has been authorized, a service provider (e.g., technician or mechanic) can document the repair work—e.g., by video recording parts that have been replaced, repaired, and/or installed. If the suggested service is declined, method 200 ends, step 218.

Any combination and/or subset of the elements of the method depicted in FIG. 2 may be practiced in any suitable order and in conjunction with any system, such as the system depicted in FIG. 1, as well as with any other device and/or process. The method shown in FIG. 2 can be implemented in any suitable manner, such as through software operating on one or more device.

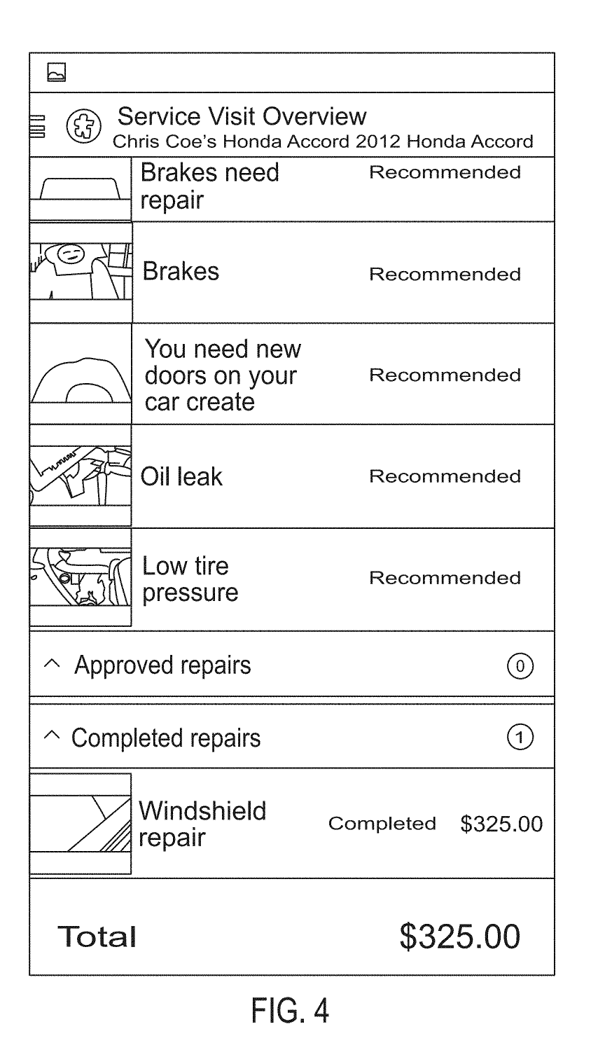

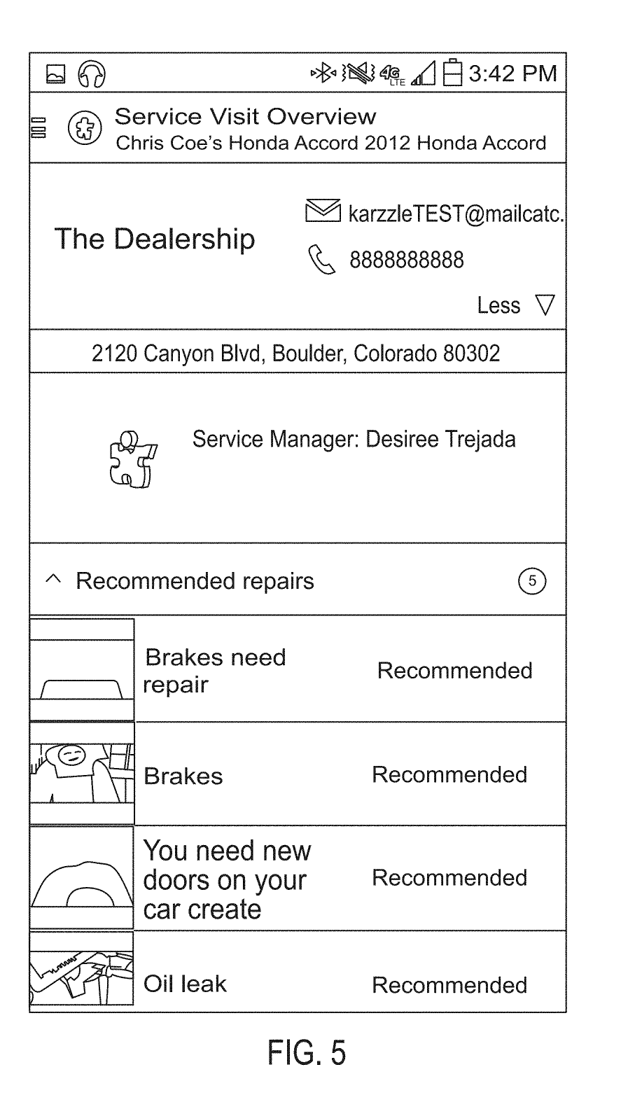

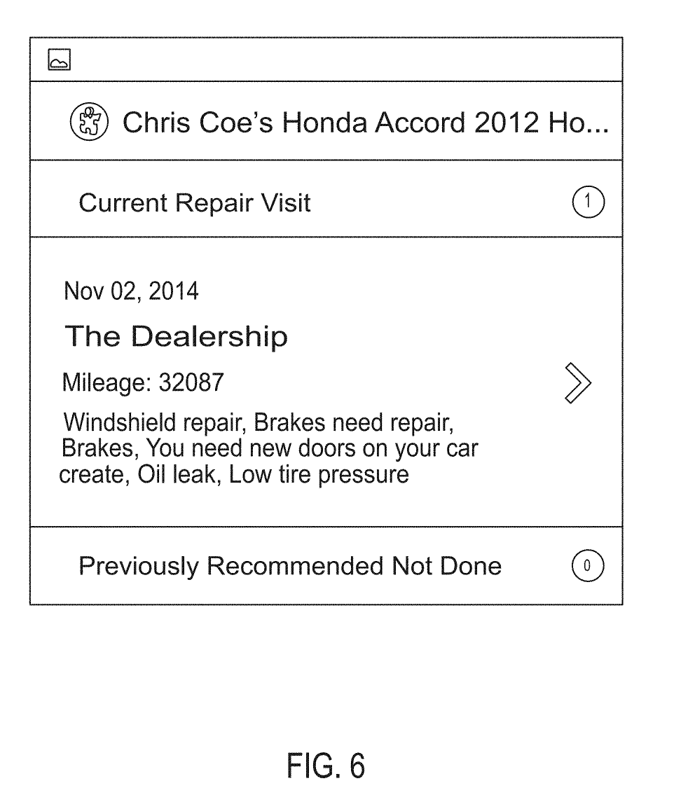

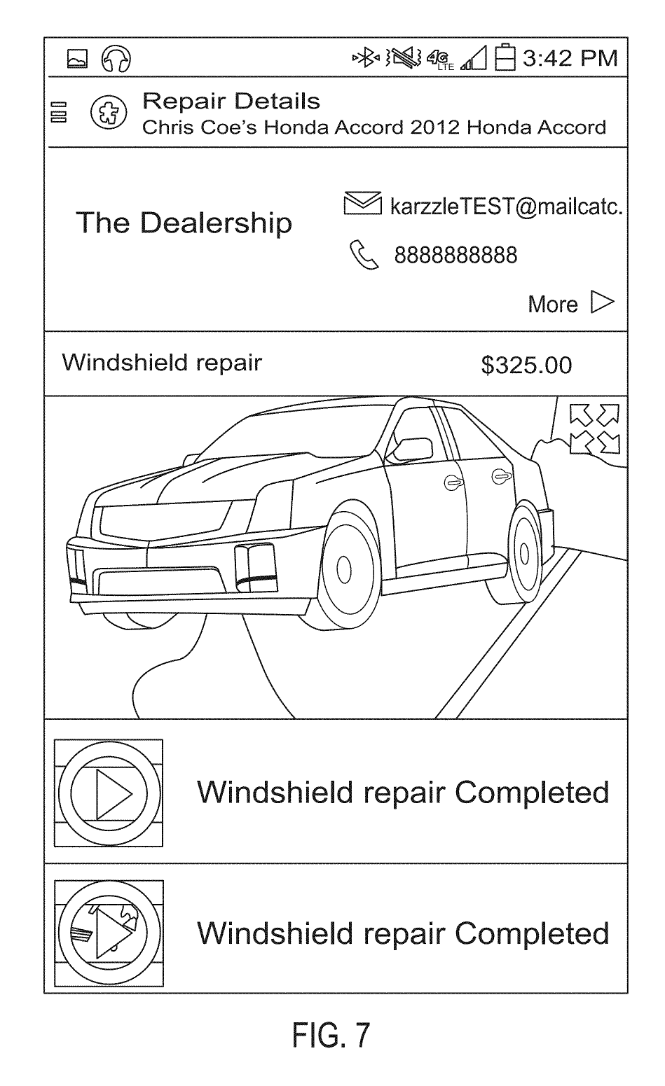

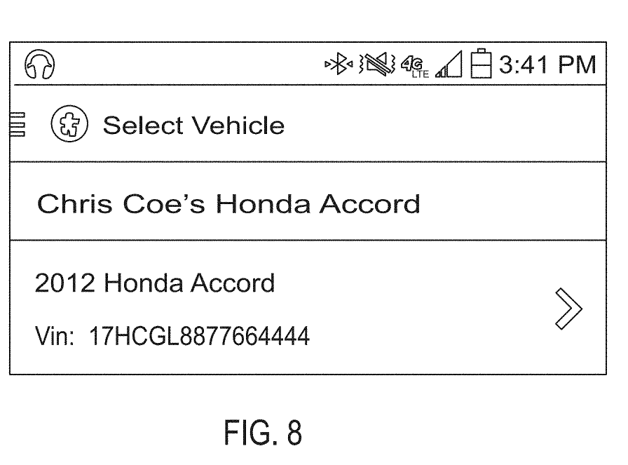

FIGS. 4-8 illustrate various screen shots from a user interface of a customer application on a customer (second) device. FIG. 4 illustrates a list of proposed services that are recommended by a service provider. FIG. 5 is another illustration of a customer user interface, illustrating service provider information in addition to a list of recommended repairs. FIG. 6 illustrates a user interface, in which a user can select information regarding a recent or current repair visit. FIG. 7 illustrates a user interface, showing a video relating to completed work, along with a price for the completed work. And, FIG. 8 illustrates an exemplary user interface, which allows a user to select a vehicle—e.g., to review proposed or past services.

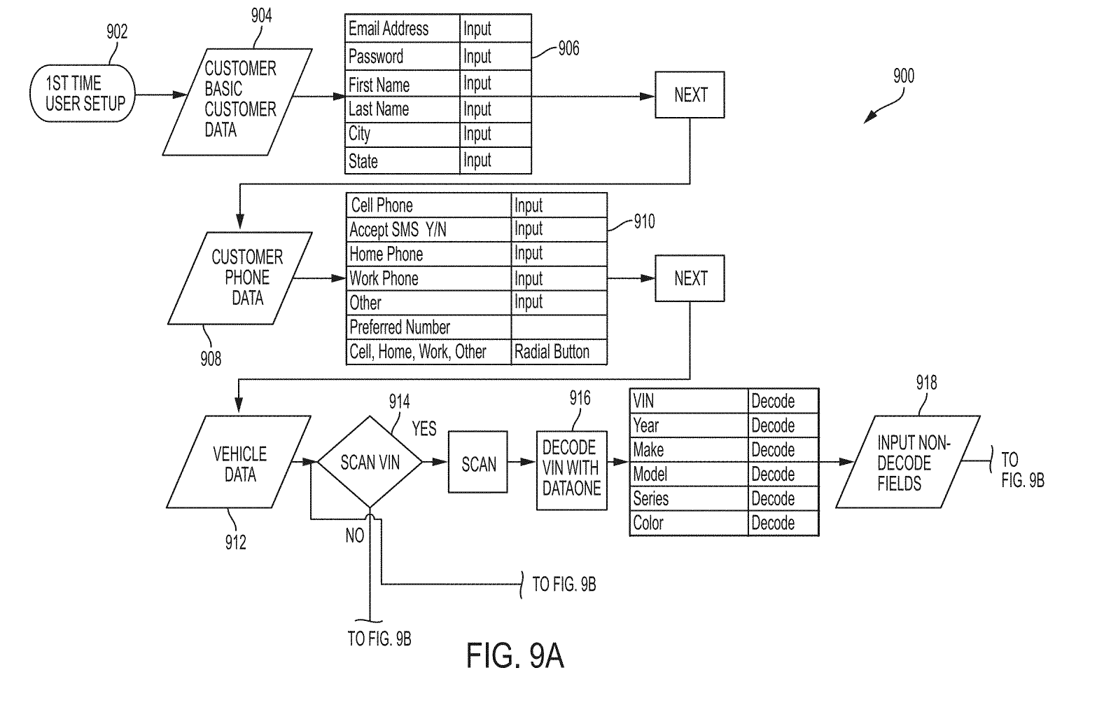

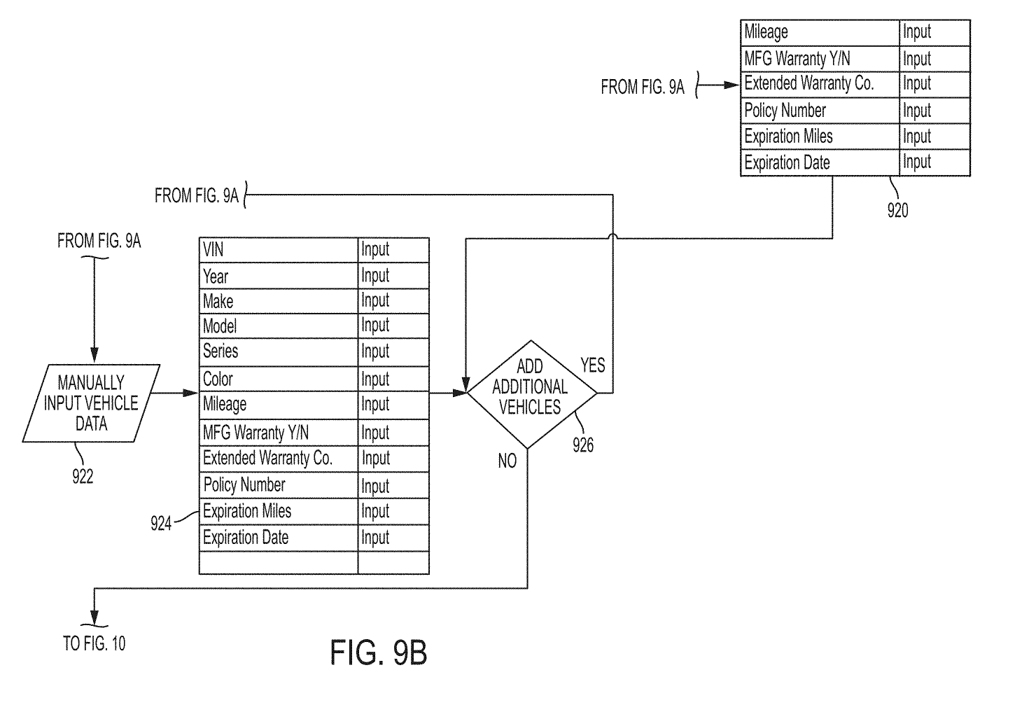

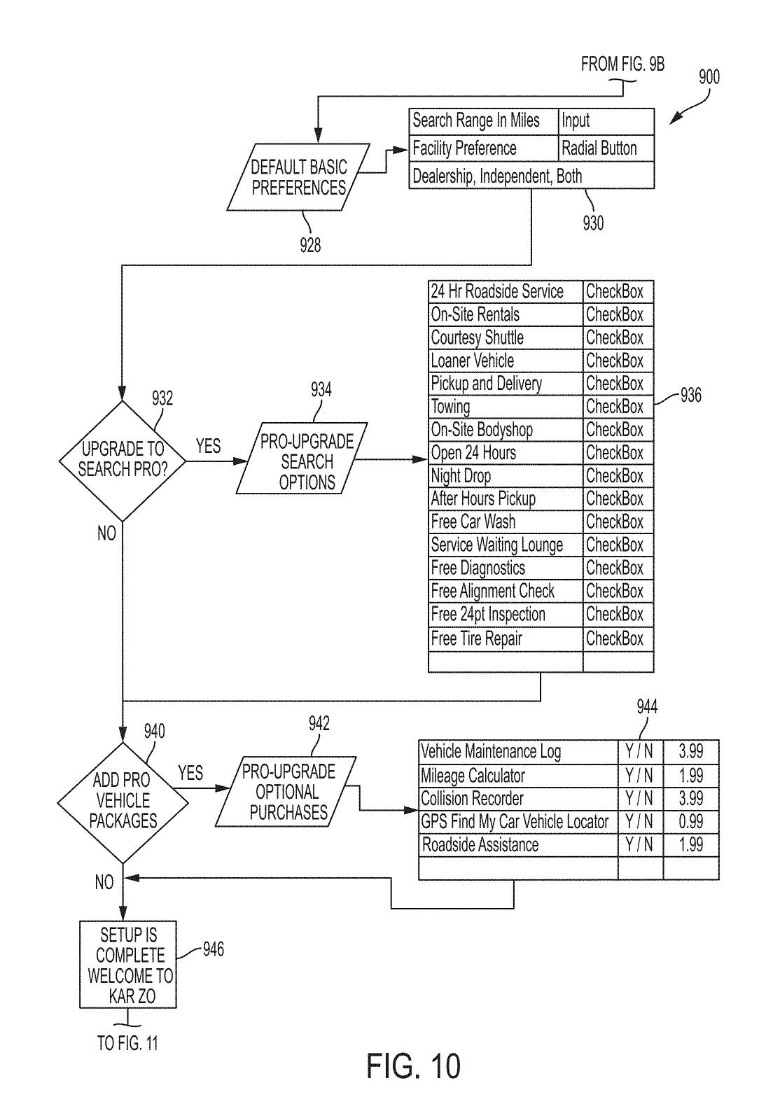

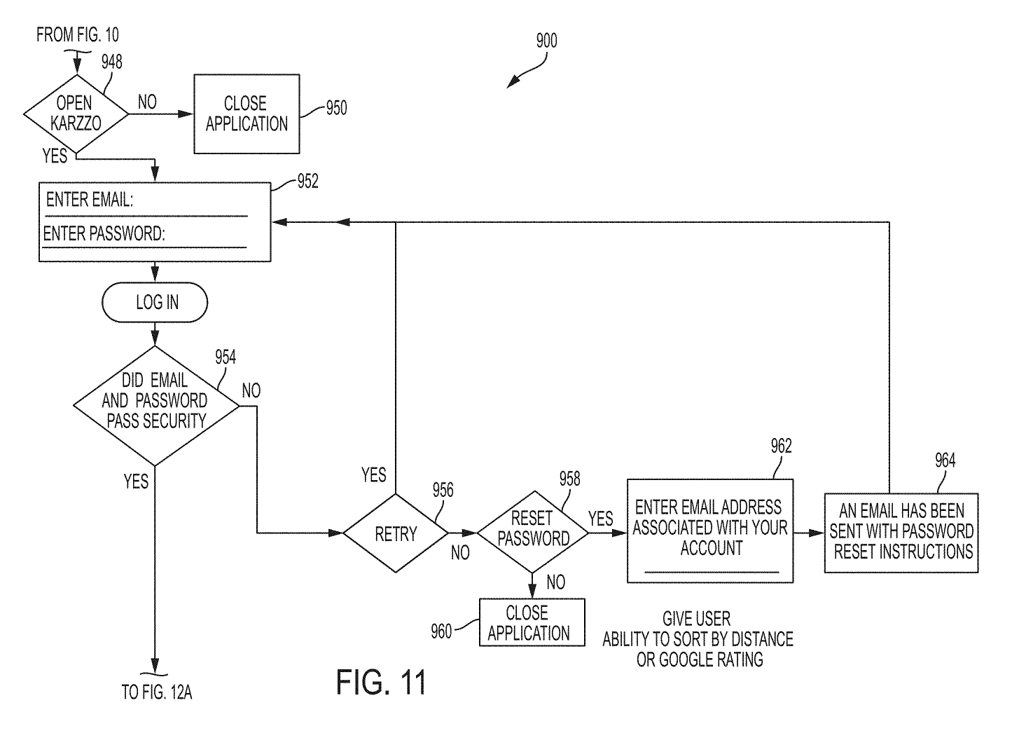

FIGS. 9A-11 illustrate a method 900 for setting up a user account and using an application in accordance with additional exemplary embodiments of the disclosure. Method 900 begins with a first-time user (e.g., customer) setup (step 902). During the initial setup, customer information 906, such as email address, password, first name, last name, and address are entered (step 904) using, for example, a service provider application as described herein. At step 908, additional information, such as contact information 910 (e.g., phone numbers, whether a device associated with a phone number accepts SMS messages) is entered. Next, vehicle information is entered (step 912). Vehicle identification information can be entered automatically—e.g., by scanning (step 914) a vehicle identification number, such as a VIN, decoding the vehicle identification information (step 916) and inputting non-decoded fields 920 (step 918). Alternatively, vehicle information 924 can be manually entered (step 922). If a user desires to enter additional information, method 900 can continue to step 914. Alternatively, method 900 continues to use default preferences (step 928), which can include fields 930, such as search range in miles, facility preferences, and dealership or independent mechanic/technician.

In the illustrated example, method 900 determines whether a user wants to upgrade the application (step 932). If yes, exemplary method 900 offers additional search options 936 (step 934). A user can then determine whether to add another additional feature (step 940), such as additional search options 944 (step 946). At step 946, the initial setup for a customer is complete.

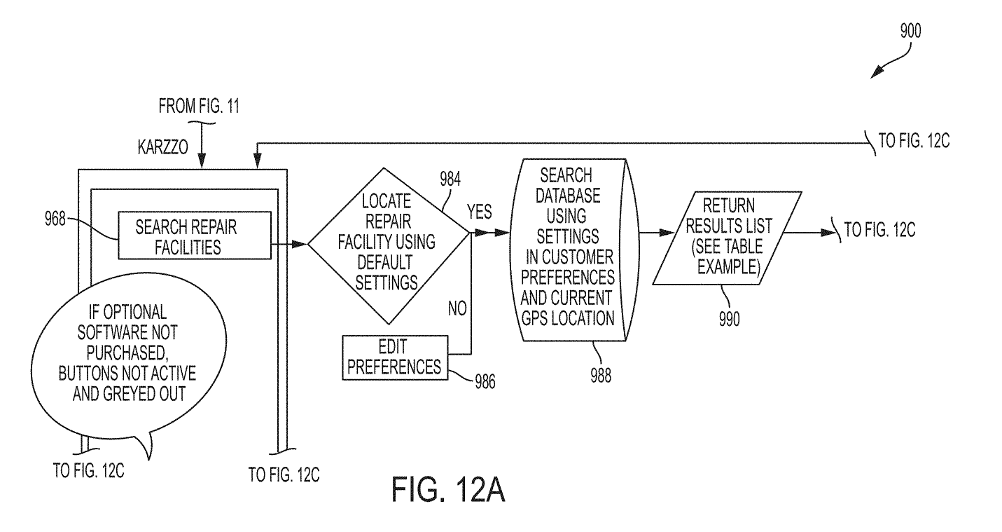

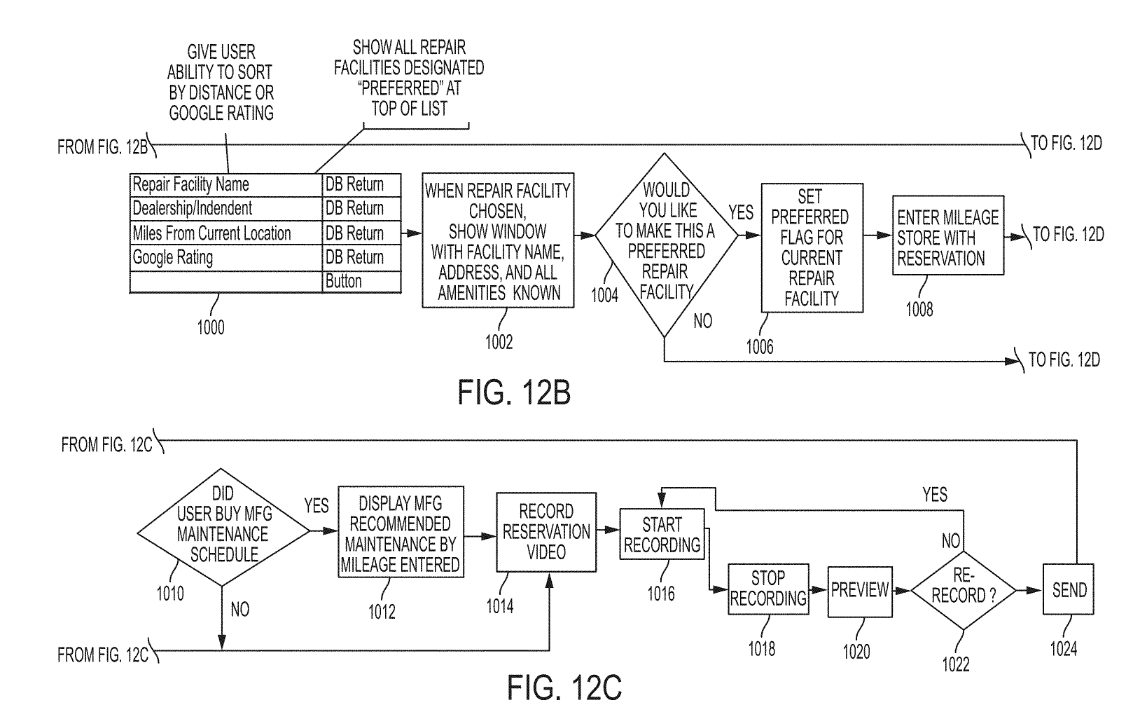

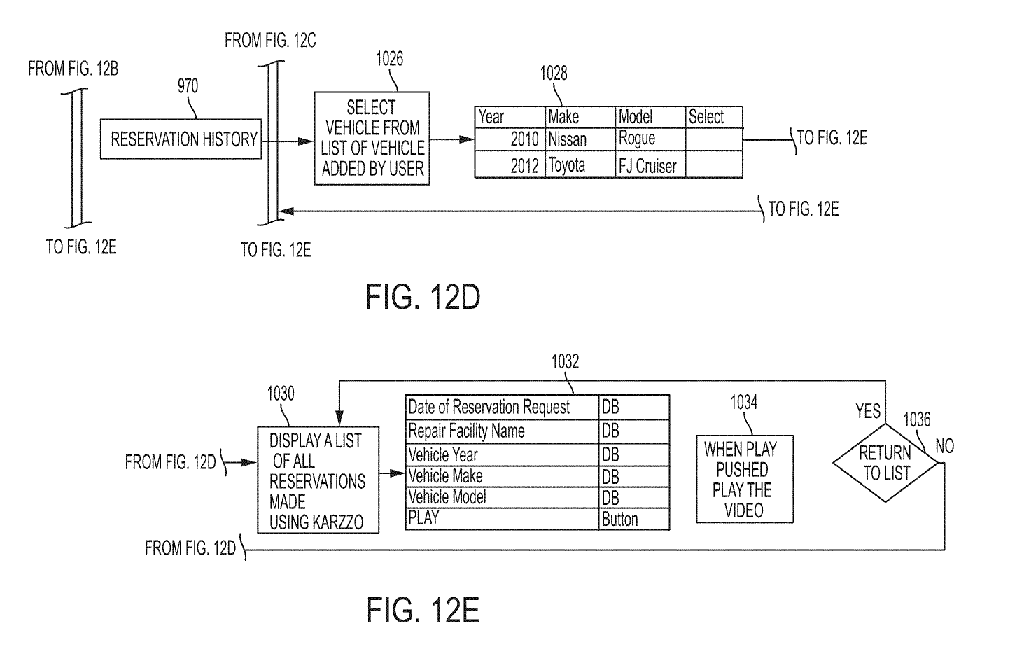

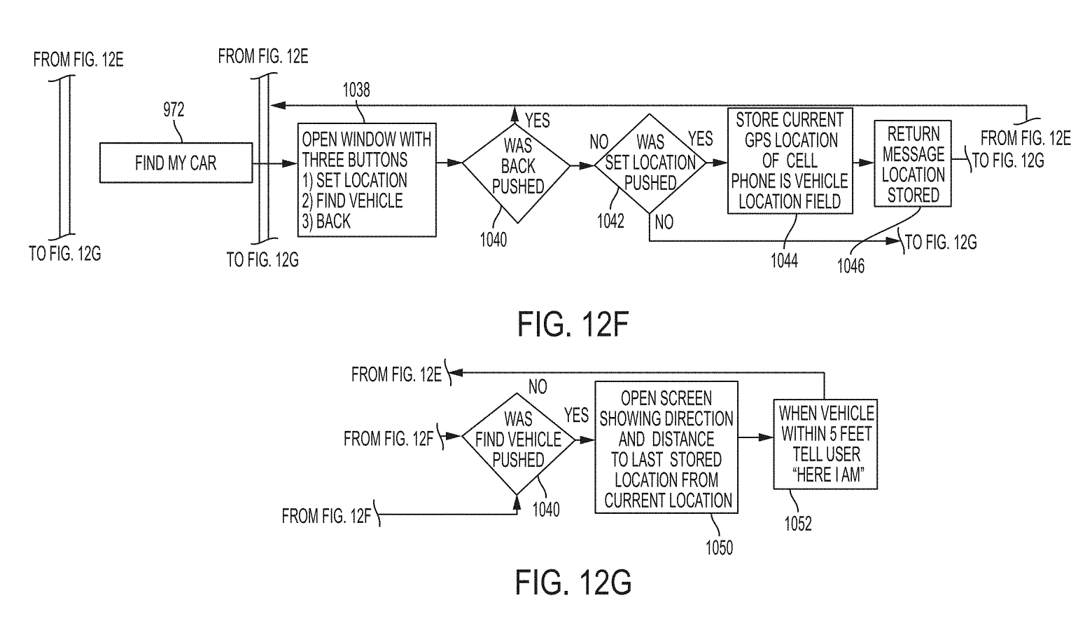

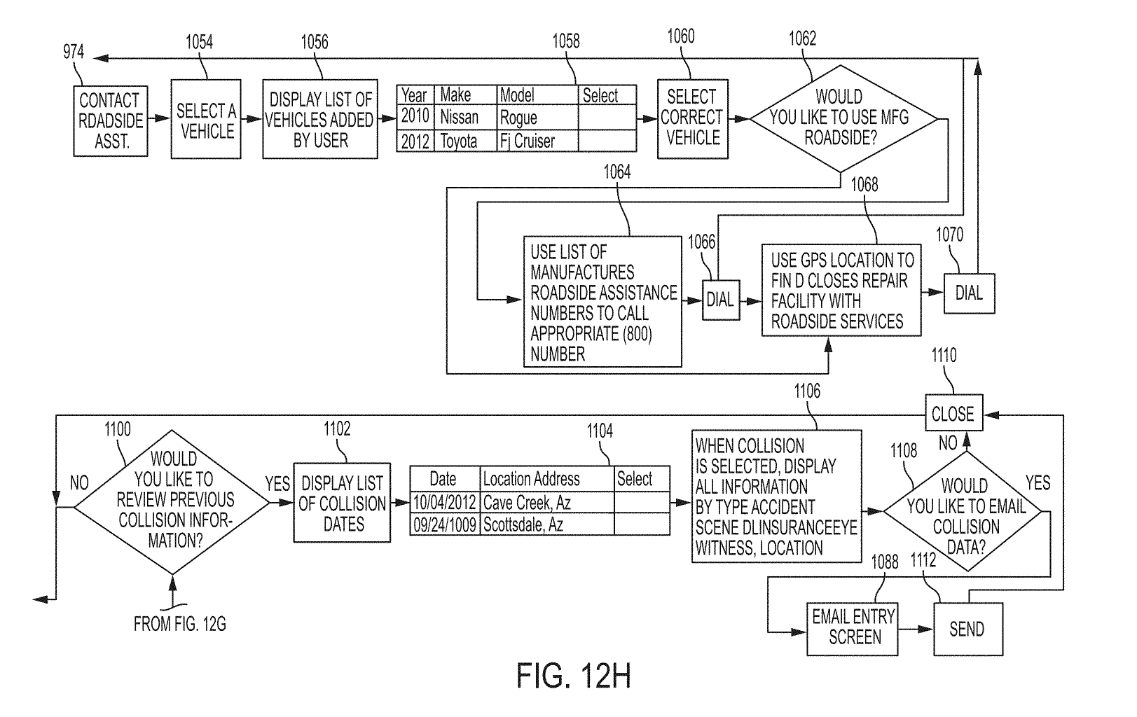

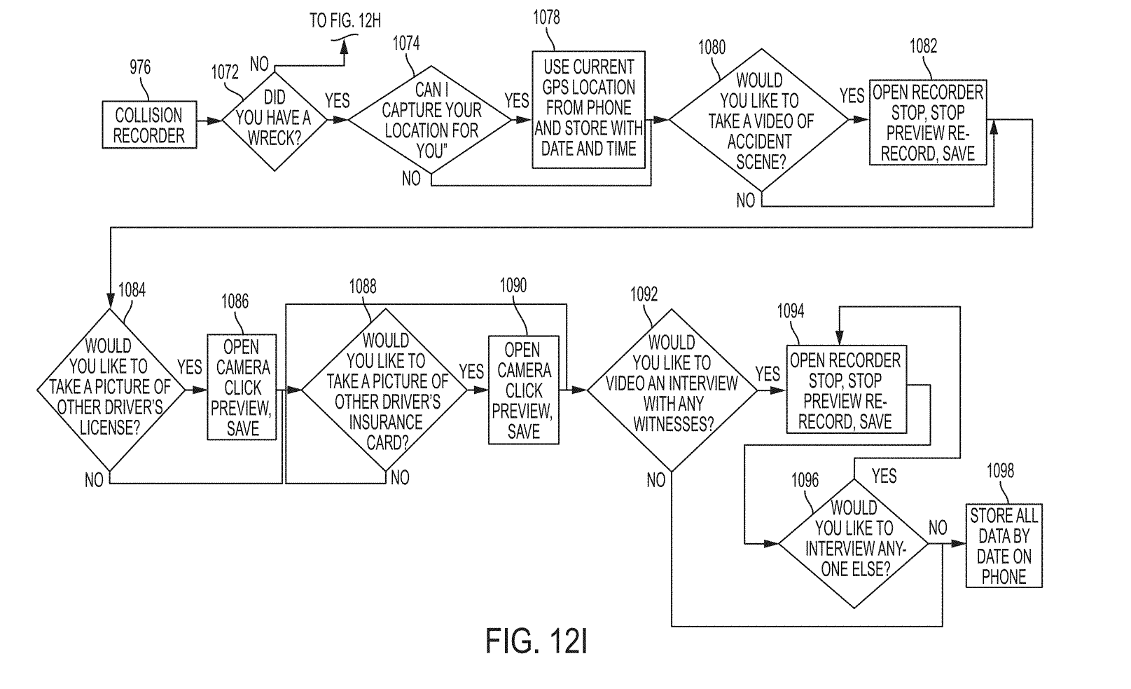

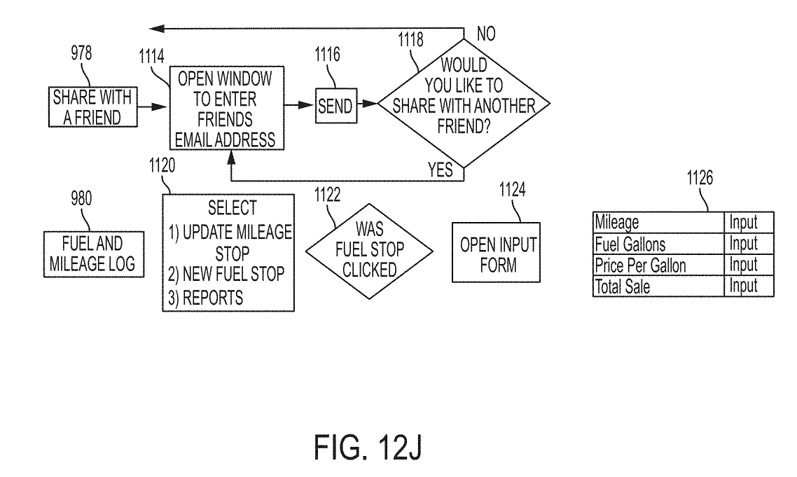

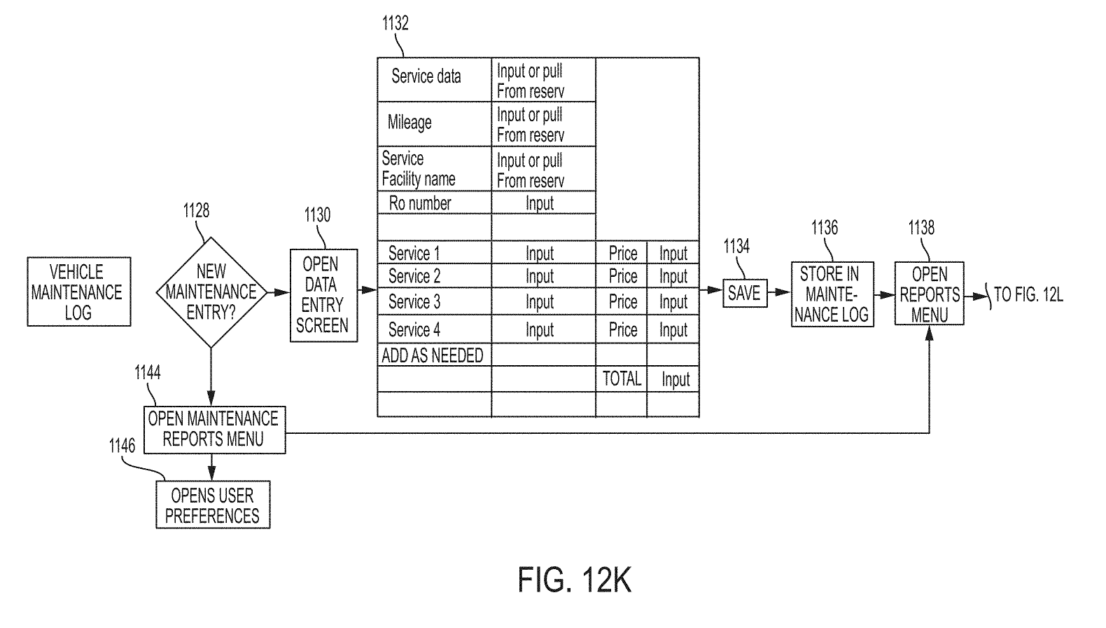

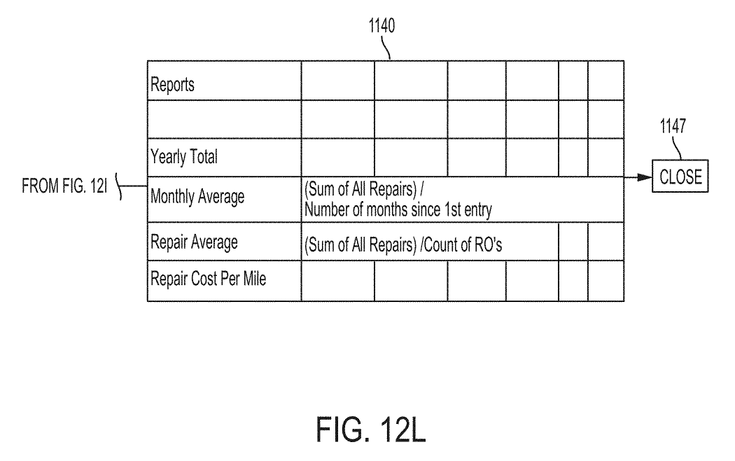

Method 900 continues on FIG. 11. Exemplary method 900 includes a step of determining whether to open the application (step 948). If no, the application closes (step 950). If yes, method 900 continues to requesting login credentials from a user (step 952). A determination (step 954) is made whether the correct credentials were entered. If yes, method 900 continues to FIGS. 12A-12L. If not, method 900 continues to the step determining whether to reset the user's password (step 958). If no, the application closes (step 960). If yes, an email address is entered (step 962) and a message that an email has been sent is displayed on the user's device (step 964).

FIGS. 12A-12L illustrate method 900 once a user has successfully logged into the application. At this point, one or more selectable options 968-982 are presented on a user interface to a user using the application. In the illustrated example, option 968 is a search repair facilities option. If selected, a decision is presented whether to locate repair facilities using default settings. If no, a user can edit preferences (step 986). If yes, a search is performed using settings in custom preferences and current GPS location (step 988). Then, return results list 1000 is presented (step 990). Next, when a repair facility is chosen (step 1002), a determination of whether to make a selected facility a preferred facility is made (step 1004). If not, method 900 proceeds to step 1014. If yes, a preferred facility is entered (step 1006). Mileage is then entered (step 1008). Next, the user is asked if a manufacturer maintenance schedule was purchased (step 1010). If no, method 900 proceeds to step 1014. If yes, a manufacturer's recommended maintenance based on the mileage entered at step 1008 is displayed (step 1012). A video record of the reservation is made (step 1014). The recording can be started (step 1016), stopped (step 1018), previewed (step 1020), rerecorded (step 1022), and sent to a service center (preferred/selected service facility) (step 1024).

At 970, a user can review a reservation history. In this case, a user can select a vehicle from a list of vehicles 1028 (step 1026). A list 1032 of reservations made for a vehicle is displayed (step 1030). When a play button on a video is selected (step 1034), a prior video is played. A user can be returned to the options list (step 1036).

At 972, an option of find my car is selected. In this case, a window with three options: (1) set location, (2) find vehicle, and (3) back is displayed. If back button was selected (step 1040), then the user returns to the “options.” If not, method 900 continues to a step of determining whether set location was selected (step 1042). If no, method 900 continues (step 1048). If yes, method 900 continues to store current GPS location (step 1044). Next, a message of location stored is displayed (step 1046). Next, a determination of was find vehicle pushed (step 1048) is made. If no, a user is returned to “options.” If yes, a screen is opened showing direction and distance to the facility from the current location (step 1050). Next, when the vehicle is close to the facility, a notification is sent to the service provider (1052).

Option 974 allows a user to contact roadside assistance. A user can select a vehicle (step 1054) from a list of vehicles 1058 displayed (step 1056). A user can verify the selected vehicle is correct (step 1060). A user can determine whether to use a manufacturer's roadside assistance (step 1062). If no, method 900 proceeds to step 1068. If yes, a list of manufacturers' roadside assistance numbers are displayed (step 1064), a selected number can be dialed (step 1066). At step 1068, a GPS location can be used to find the closest repair facilities (step 1069), and a corresponding number can be dialed (step 1070).

At option 976, a user can select whether or not the user was in an accident (step 1072). If yes, the user is presented with an option to allow the application to capture the location of the vehicle (step 1074). If no, method 900 continues to step 1080. If yes, a GPS location and optionally a date and time are stored (step 1078). At step 1080, a user is asked whether he or she would like to take a video of the accident. If no, method 900 proceeds to step 1084. If yes, a recorder and suitable interface are opened (step 1082). At step 1084, a user is asked whether he or she would like to take a photograph of the other person's driver's license. If no, method 900 proceeds to step 1088. If yes, a camera interface with options to take a picture, preview, and save is presented (step 1086). At steps 1088, 1090, a user can determine and select to take additional photographs of the accident. A determination to video record a witness can be made (step 1092), a recorder interface can be opened (step 1094), a determination whether to interview anyone else (step 1095), and store data (step 1098) can be performed.

Returning to step 1072, if no, method 900 proceeds to steps 1100 of determining whether to review previous collision information. If no, the user can return to “options.” If yes, a list of collision dates 1104 is presented (step 1102). Once a collision date is selected, information regarding the collision is displayed (step 1106). An option to email collision date (step 1108) can be presented. If yes, the information can be sent to a stored email address.

Option 978 allows a user to share information with friends. At step 1114, a window is opened to allow a user to enter one or more email addresses. The information is sent (step 1116), and an option to email or otherwise share with another friend is presented (step 1118).

Option 980 allows a user to enter information into a fuel and mileage log. At step 1120, a user can select an option of (1) update mileage stop, (2) new fuel stop, and (3) reports. If fuel stop checked is selected (step 1122), an input form 1126 is opened (step 1124).

Option 982 is a vehicle maintenance log. At step 1128, a user selects whether to enter a new maintenance entry. If yes, a new data entry form 1132 is displayed (step 1130). The information is saved (step 1134) and stored in a maintenance log (step 1136). If no to step 1128, method 900 proceeds to step 1138 to open a report menu 1140. At step 1142, option 982 is closed. The “options” can include additional, alternative, and variations of the options noted herein. For example, the “options” can include “user preferences” 1146.

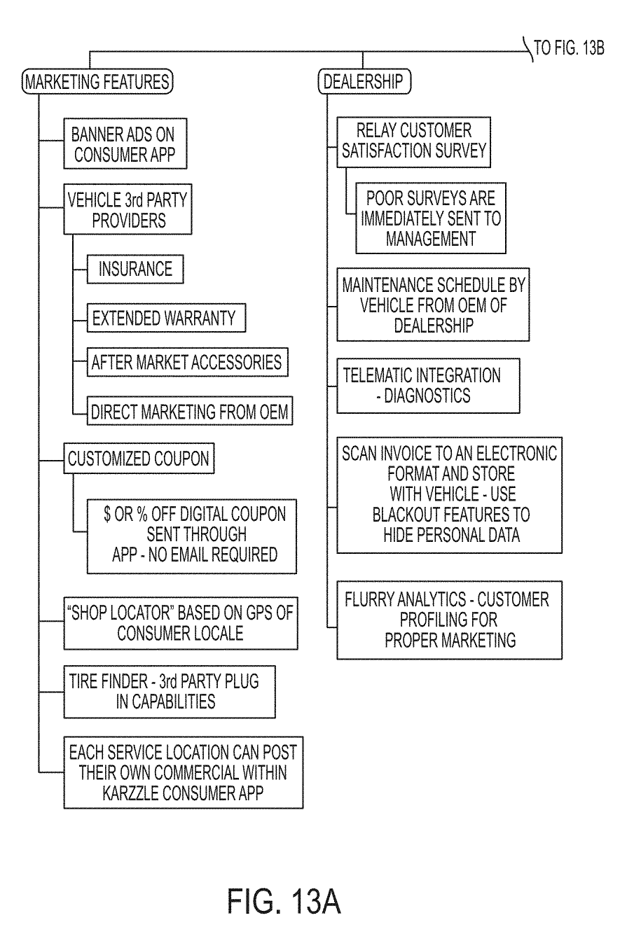

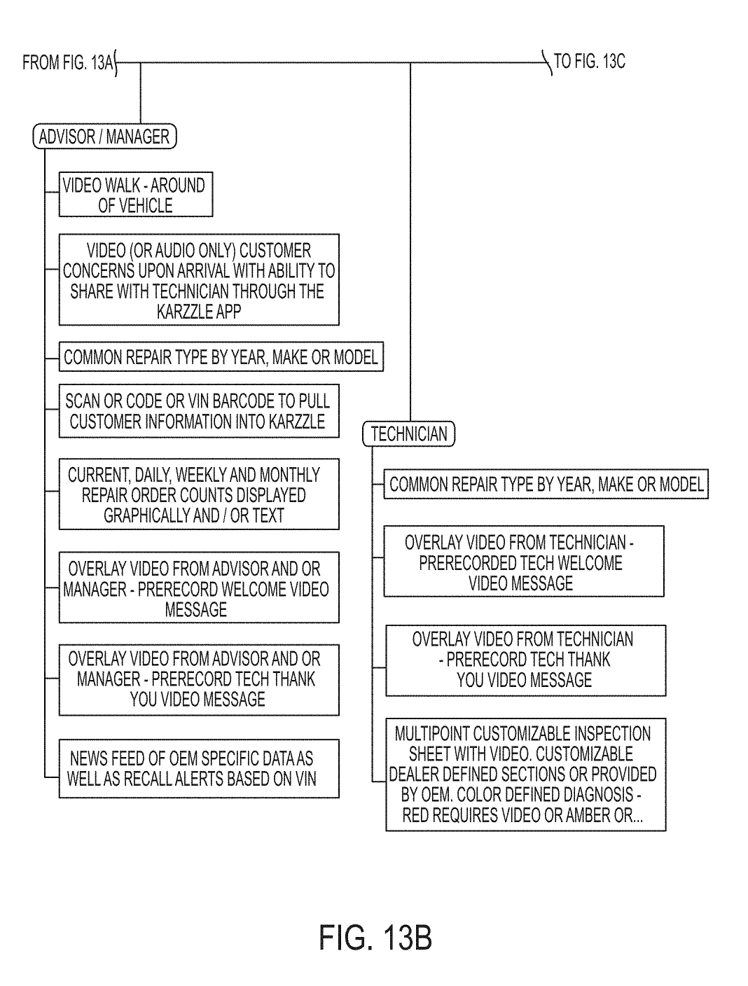

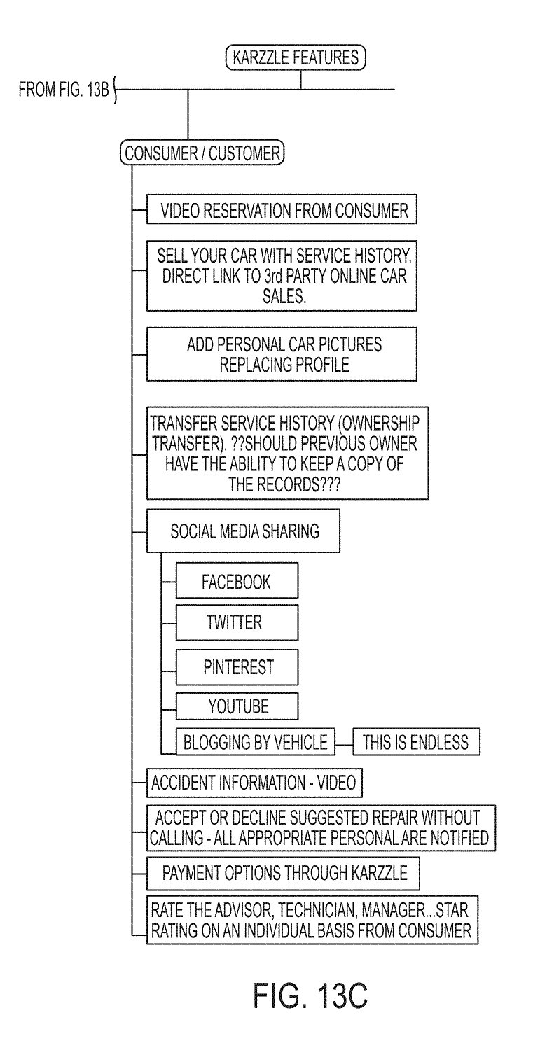

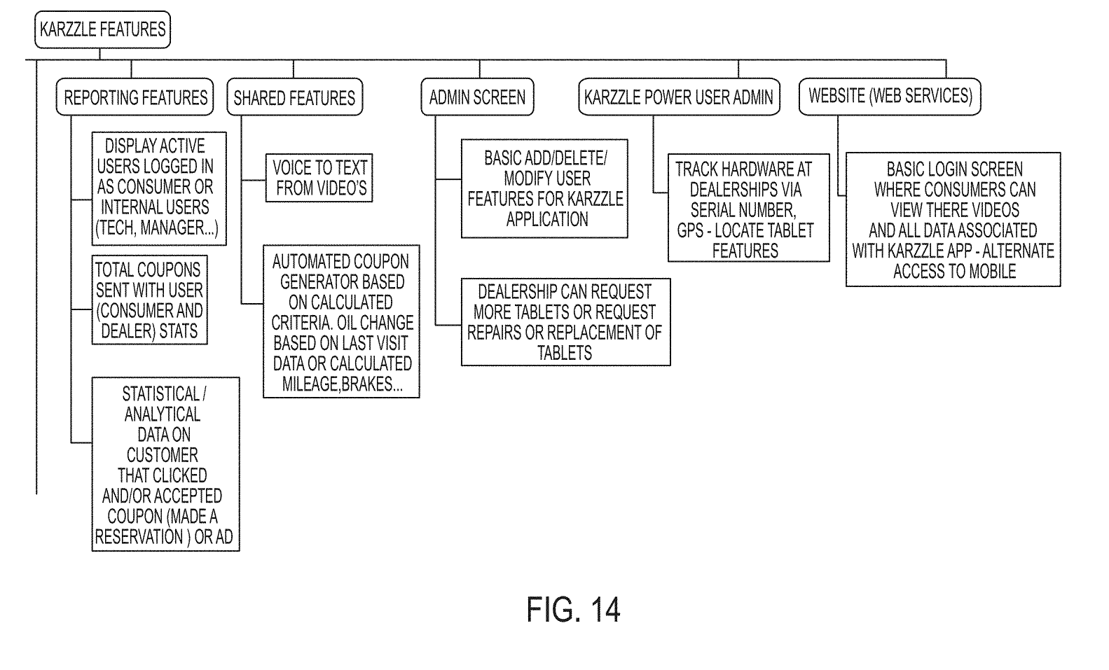

The methods and systems described herein can include a variety of additional features, such as those described in FIGS. 13A-13C and FIG. 14.

As noted above, while the present invention has been described with regards to its use in enhancing customer service for service providers in the automotive sector (such as car dealerships and repair centers providing services on vehicles), the present invention may be utilized in many other fields. For example, the present invention may be utilized to provide patients of a hospital or doctor with information on medicines prescribed for the patient, as well as for procedures (such as a surgery) performed for the patient. Likewise, the present invention may be used to provide information and enhance customer service for customers in the field of law, where the present invention can provide clients access to long and/or complicated legal advice, statutes, documents, or other information. The security features associated with the present invention can allow a client to safely retain and retrieve important documents such as wills and contracts without fear they will be lost or destroyed. Similarly, the present invention can allow audio, photos, video, and other information pertaining to a home inspection, appraisal or real estate transaction to be provided to a customer. The present invention may also be used to provide a customer with information related to insurance policies, coverage, and claims. The present invention may be used in conjunction with any other service-related field.

The particular implementations shown and described above are illustrative of the invention and its best mode and are not intended to otherwise limit the scope of the present invention in any way. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following examples.

Some specific examples of the disclosure include the following.
1. A system for facilitating review of proposed services, the system comprising:
   a network;
   a first device having a provider application, the first device coupled to the network; and
   a second device having a customer application, the second device coupled to the network, wherein the provider application allows a user to capture information (e.g., video) documenting proposed services to be provided,
   wherein the customer application displays information (e.g., video) regarding the proposed services, and
   wherein the customer can use the application to contact the user in response to the proposed services.
2. The system of example 1, further comprising a database coupled to the network, wherein the database comprises consumer information.
3. The system of example 2, wherein the system further comprises a web services server and the database forms part of the web services server.
4. The system of example 2, wherein customer information comprises customer contact information.
5. The system of example 2, wherein customer information comprises a vehicle identification number.
6. The system of any of examples 1-5, further comprising a streaming server coupled to the network.
7. The system of example 6, wherein the streaming server comprises a profile page.
8. The system of any of claims 6-7, wherein the streaming server comprises a streaming server application.
9. The system of example 8, wherein the streaming server application determines a communication bandwidth of the network.
10. The system of any of claims 8-9, wherein the streaming server application determines an operating system of the second device.
11. The system of any of claims 8-10, wherein the streaming server application compresses the information documenting proposed services.
12. The system of example 11, wherein the streaming server application further causes the compressed information documenting proposed services to be transmitted to the second device.
13. The system of example 12, wherein the transmission comprises streaming.
14. The system of any of examples 1-13, further comprising a third device comprising a warranty provider application.
15. The system of any of examples 1-14, wherein the customer application sends a notification to the provider application when the customer causes to be displayed information (e.g., video) regarding the proposed services.
16. The system of any of examples 1-15, wherein the provider application sends a coupon to the customer application.
17. The system of any of examples 1-16, wherein the customer application receives a notification when the information documenting proposed services to be provided is ready to be viewed.
18. A method for reviewing proposed services, the method comprising the steps of:
   storing customer information in a database;
   using a first device, capturing information regarding the proposed services;
   streaming the information regarding the proposed services to a streaming server;
   using the streaming server, compressing and/or encoding or transposing the information regarding the proposed services; and
   sending the compressed encoded and/or transposed information regarding the proposed services to a second device.
19. The method of example 18, wherein the step of compressing is performed in real-time.
20. The method of any of examples 18-19, further comprising a step of using the streaming server, determining a type of the second device.
21. The method of any of examples 18-20, wherein the customer information comprises a vehicle identification number.
22. The method of any of examples 18-21, wherein the customer information comprises a history of related services.
23. The method of any of examples 18-22, further comprising a step of sending to the second device a cost estimate of the services.
24. The method of any of examples 18-23, further comprising a step of sending a notification from the second device to the first device, wherein the notice indicates whether a customer has reviewed the compressed information.
25. The method of any of examples 18-24, wherein the step of sending is automatic.
26. The method of any of examples 18-25, further comprising a step of recording (video and/or audio) a conversation with a customer.
27. The method of example 26, wherein the step of recording comprises recording a description of services desired by the customer.
28. The method of any of example 26-27, wherein the step of recording comprises recording a description of services provided by a service provider.
29. A method of presenting proposed services, the method comprising the steps of:
   providing a first device having a first application;
   providing a second device having a second application;
   providing a steaming server connected to the first device and the second device;
   providing a database connected to the steaming server;
   using the first device, capturing a vehicle identifier;
   storing the vehicle identifier in the database;
   using the first device, streaming electronic information regarding proposed services to the steaming server;
   using the steaming server, compressing the information regarding proposed services; and
   using a network, transmitting the compressed information to the second device.
30. The method of example 29, further comprising a step of storing service provision history on the database.
31. The method of any of examples 29-30, further comprising a step of performing analytics using the customer information.
32. The method of any of examples 29-31, wherein the customer information is associated with one or more of: a name, a vehicle identification number, and a customer identification.
33. The method of any of examples 29-32, further comprising a step of accepting one or more proposed services using one or more of: an e-mail, a phone call, a button displayed by the application.
34. The method of any of examples 29-32, further comprising a step of NOT accepting one or more proposed services using one or more of: an e-mail, a phone call, a button displayed by the application.
34. The method any of examples 29-33, further comprising a step of, using the first application, creating a recommend service.
35. The method of example 34, wherein the step of creating a recommended service comprises selecting a service from a list of services.
36. The method of any of examples 34-35, wherein the step of creating a recommended service comprises using speech-to-text to describe the recommended service.
37. The method of any of examples 34-36, wherein the step of creating a recommended service comprises video recording of a part to be repaired or replaced.
38. The method of any of examples 34-37, wherein the step of creating a recommended service further comprises a step of previewing video information.
39. The method of any of examples 34-38, wherein the step of creating a recommended service further comprises locating a separate record for each recommended repair.
40. The method of any of examples 34-39, wherein the step of creating a recommended service further comprises a step of capturing video information to show completed work.
41. The method of example 29, further comprising a step of reviewing the electronic information regarding proposed services.
42. The method of example 41, further comprising a step of discarding reviewed electronic information and performing another step of capturing.
43. The method of any of examples 29-42, wherein a format used during the step of compressing depends on a type of the second device.
44. The method of any of examples 29-43, wherein the second device comprises a device selected from the group consisting of a mobile phone, a tablet, and a computer.
45. The method of any of examples 29-44, wherein the streaming server identifies an operating system of the second device and formats the compressed information according to the operating system.
46. The method of example any of examples 29-45, further comprising a step of using the streaming server, determining a bandwidth of communication between the steaming server and the second device.
47. The method of any of examples 29-46, wherein compressed video comprises high-definition video.
48. The method of any of examples 29-47, wherein the database stores a vehicle identification number and a history of services associated with the vehicle identification number.
49. The method of example 48, wherein the history of services includes electronic video information corresponding to recommended service.
50. The method of any of examples 48-49, wherein the history of service includes information corresponding to completed services.
51. The method of any of examples 29-50, wherein the second application runs in the background on the second device.
52. The method of any of examples 29-51, wherein the database comprises recommended but not yet completed work/services.
53. The method of any of examples 29-52, further comprising a step of displaying a price associated with the service.
54. A system for facilitating review of proposed services, the system comprising:
   a network;
   a first device having a provider application, the first device coupled to the network; and
   a second device having a customer application, the second device coupled to the network,
   wherein the provider application allows a user to capture information (e.g., video) documenting proposed services to be provided,
   wherein the customer application displays information (e.g., video) regarding the proposed services, and
   wherein the customer can use the application to contact the user in response to the proposed services.

Additional specific examples of the disclosure include the following.
1. A system for creating a vehicle file, the system comprising:
   (a) one or more data input devices, the one or more data input devices programmed to record and transmit video data regarding a vehicle;
   (b) a server for receiving and storing the video data from the one or more data input devices; and
   (c) a receiving device configured for receiving the video data from the server by entering security information via the device, the security information for transmission to the server to establish that the device is authorized to receive the video data.
2. The system of example 1 wherein the server transmits the video file to the receiving device.
3. The system of example 1 or 2 that further includes an API that transmits the video data to the receiving device.
4. The system of example 1 wherein the receiving device is one of the group consisting of: a lap top computer, a desk top computer, a cellular phone, and a tablet.
5. The system of any of examples 1-4 wherein the receiving device is a portable electronic device.
6. The system of example 1 wherein the one or more data input devices is a tablet.
7. The system of any of examples 1-6 wherein the one or more data input devices is wireless.
8. The system of any of examples 1-6 wherein the one or more data input devices transmits the video data wirelessly.
9. The system of any of examples 1-8 wherein the server compresses the video data.
10. The system of any of examples 1-8 wherein the serves stores the video data in a discrete file.
11. The system of example 10 wherein the discrete file is associated with a specific vehicle.
12. The system of example 11 wherein the discrete file is identified by a vehicle identification number.
13. The system of example 3 wherein the API verifies a type of the receiving device.
14. The system of example 13 wherein the API formats the video data based on the type of receiving device.
15. The system of example 14 wherein the formatting of the video data includes compression of the video data.
16. The system of any of examples 1-15 wherein the video data is displayed on the data input device as it is recorded.
17. The system of any of examples 1-16 wherein the receiving device includes an operating system and software on the operating system, the software programmed to receive the video data from the server.
18. The system of example 17 wherein the receiving device has a screen and the software is operable to display a homepage on the screen, the homepage including a window for receiving the security information to be transmitted to the server.
19. The system of example 18 wherein the device has keys for inputting information, including the security information.
20. The system of example 18 or 19 wherein the software can store the security information.
21. The system of any of examples 1-19 wherein there is a single data input device.
22. The system of any of examples 1-20 wherein there are multiple data input devices.
23. The system of any of examples 1-20 or 22 wherein the one or more data input devices stores the video data.
24. The system of example 22 wherein the single data input device stores the video data.
25. The system of example 23 wherein the one or more data input devices stores the video data temporarily.
26. The system of any of examples 1-20, 22 or 25 wherein the one or more data input devices displays the video data while the video data is recorded.
27. The system of any of examples 1-20, 22, or 25-26 wherein the one or more data input devices transmits the video data to the server after the video data is recorded.
28. The system of any of examples 1-27 wherein the video data can be erased from the one or more data input devices after being transmitted.
29. The system of any of examples 1-28 wherein the one or more data input devices are further programmed to record audio data and transmit the audio data to the server, and the receiving device is further configured to receive the audio data from the server.
30. The system of example 29 wherein the server transmits the audio file to the receiving device.
31. The system of any of examples 29-30 wherein the server compresses the audio data.
32. The system of any of examples 29-31 wherein the server stores the audio data in a discrete file.
33. The system of any of examples 28-32 wherein the audio data is played on the data input device as it is being recorded.
34. The system of any of examples 28-33 wherein the receiving device includes an operating system and software on the operating system, the software for receiving the audio data from the server.
35. The system of any of examples 28-34 wherein each data input device stores the audio file.
36. The system of example 35 wherein each data input device stores the audio file temporarily.
37. The system of any of examples 29-36 wherein each data input device transmits the audio data after the audio data is recorded.
38. The system of any of examples 29-37 wherein the audio data can be erased from each data input device after being transmitted to the server.
39. The system of example 22 wherein the single data input device stores the video data temporarily.
40. The system of example 39 wherein the single data input device stores the video data at least until the video data is transmitted to the server.
41. The system of example 25 wherein the one or more data input devices store the video data at least until the video data is transmitted to the server.
42. The system of example 24, 39 or 40 wherein the single data input device transmits the video data to the server after the video data is recorded.
43. The system of example, 24, 39 or 40 wherein the single data input device displays the video data while it is being recorded.
44. The system of any of examples 29-38 wherein the server stores the video data and a second server stores the audio data.
45. The system of example 44 wherein the video data in the server is stored in a first discrete file and the audio data in the second server is stores in a second discrete file corresponding to the first discrete file.
46. The system of example 45 wherein the first discrete file is associated with a specific vehicle and the second discrete file is associated with the specific vehicle.
47. The system of example 45 or 46 wherein the first discrete file and the second discrete file are identifiable by a vehicle identifier.
48. The system of example 47 wherein the vehicle identifier is vehicle identification number.
49. The system of any of examples 44-48 wherein the receiving device is configured to receive the video data from the server and the audio data from the second server.
50. The system of example 49 wherein the receiving device simultaneously receives video data from the server and audio data from the second server.
51. The system of any of examples 1-50 wherein the video data relates to suggested repairs or maintenance for a vehicle.
52. The system of example 51 wherein the video data also relates to repairs or maintenance performed on a vehicle.
53. The system of any of examples 29-49 wherein the audio data relates to suggested repairs or maintenance for a vehicle.
54. The system of example 53 wherein the audio data also relates to repairs or maintenance performed on a vehicle.
55. The system of any of examples 1-43 wherein the receiving device is configured to send an authorization to the server for the server to send data to the receiving device.
56. The system of any of examples 44-54 wherein the receiving device is configured to send an authorization to the server or to the second server for the server to send data to the receiving device.
57. The system of any of examples 1-54 wherein the video data is transmitted to the receiving device in a SMS message or an email.
58. The system of any of examples 29-49 wherein the audio data is transmitted to the receiving device in a SMS message or an email.
59. The system of any of examples 55-56 wherein the authorization is sent wirelessly.
60. The system of any of examples 57-58 wherein the video data and/or audio data are transmitted wirelessly.
61. The system of any of examples 1-60 wherein the server includes multiple files of video data regarding a specific vehicle.
62. The system of any of examples 29-49, 52 or 58 wherein the server or second server includes multiple files of audio data regarding a specific vehicle.
63. The system of example 61 wherein the multiple files of video data can be accessed by accessing the file for the specific vehicle.
64. The system of example 62 wherein the multiple files of audio data can be accessed by accessing the file for the specific vehicle.
65. The system of example 61 wherein the multiple video files include one or more of:
   (a) a history of repairs or maintenance suggested for the specific vehicle,
   (b) a history of repairs or maintenance performed on the specific vehicle, and
   (c) a history of an owner of the specific vehicle accepting or rejecting suggested repairs or maintenance.
66. The system of example 62 wherein the multiple audio files include one or more of:
   (a) a history of repairs or maintenance suggested for the specific vehicle,
   (b) a history of repairs or maintenance performed on the specific vehicle, and
   (c) a history of an owner of the specific vehicle accepting or rejecting suggested repairs or maintenance.
67. The system of example 62 wherein the server or second server includes multiple files of audio data regarding a specific vehicle and the server includes multiple files of video data regarding a specific vehicle, wherein each file of audio data corresponds to a file of video data.
68. The system of example 62 wherein upon a request from the receiving device at least on file of audio data and the file of video data that corresponds to the file of audio data is transmitted to the receiving device by either the server, the server and the second server, or the API and the second server.
69. The system of any of examples 1-68 wherein there is an interface for a service technical to access information from the server.
70. The system of any of examples 29-49, 52, 58, 66-68 wherein there is an interface for a service technician to access information from the second server.
71. The system of example 70 wherein the service technician can add one or more of the following to the video file or the audio file:
   (a) a price for suggested repair or maintenance,
   (b) an advertisement,
   (c) a discount coupon for parts or services,
   (d) offers for other repairs or maintenance,
   (e) a phone number, email address or SMS address for the vehicle owner to contact the service technician.
72. The system of any of examples 1-70 wherein data retrieved by the receiving device from one or both of the server or the second server (if utilized) includes one or more of:
   (a) a price for suggested repair or maintenance,
   (b) an advertisement,
   (c) a discount coupon for parts or services,
   (d) offers for other repairs or maintenance,
   (e) a phone number, email address or SMS address for the vehicle owner to contact the service technician.
73. The system of any of example 1-72 wherein software is downloaded onto the receiving device prior to the receiving device being capable of receiving data from the server or second server (if utilized).
74. The system of any of examples 1-72 wherein data transmitted to the receiving device includes one or more of a phone number, email address or SMS address to contact a vehicle repair center that created the video data and (if utilized) the audio data.
75. The methods as performed, respectively, by each of system examples 1-74.
76. A system for facilitating vehicle maintenance, the system comprising:
   a server having a memory and being programmed to compress and store video files, and further having at least one user interface for receiving data from a user, the data including video data, the memory configured to store data received by the user for a specific vehicle in a file for that specific vehicle, wherein the file for each specific vehicle includes identification indicia unique to that vehicle.
77. The system of example 75 wherein the identification indicia is the vehicle identification number.
78. The system of example 76 or 77 wherein the data further includes one or more of: audio data, text, advertisements, prices, and contact information.
79. The system of any of examples 76-78 wherein the video data is received wirelessly from a remote source and the server has an API programmed to receive the video data and enter it into the server.
80. The system of example 78 wherein the data is received wirelessly from a remote source and the server has an API programmed to receive the video data and enter it into the server.
81. The system of any of examples 76-80 wherein the file for each specific vehicle includes data entered at different dates and times for the specific vehicle.
82. The system of example 81 wherein each data entered at a different date and time includes the date and time the data was created.
83. The system of example 82 wherein each data entered at a different time is stored in a subfile within the specific vehicle file.
84. The system of any of examples 76-83 wherein the data can be retrieved from the server.
85. The system of any of examples 76-83 wherein the video data includes one or more of:
   (a) images of a vehicle before it enters a repair shop,
   (b) images of a vehicle showing one or more areas that require repair,
   (c) images of a vehicle showing repair work being performed, and
   (d) images of a vehicle after repair work is completed.
86. The system of example 84 wherein a specific vehicle file can be retrieved using the identification indicia unique for that vehicle.
87. The system of example 85 wherein specific vehicle data can be retrieved by using the identification indicia unique for that vehicle and the date and time associated with the data.
88. The system of example 84 wherein the server configures the specific vehicle data to be displayed in one of the following formats:
   (a) chronologically,
   (b) by the entity that performed the repairs, or
   (c) by the type of maintenance or repair performed.
89. The system of any of examples 76-88 wherein the system further includes a data input device configured to input the data into the server wherein the data input device is remote to the server.
90. The system of example 89 that further includes an API in communication with the server wherein the data input device is programmed to send a communication to the API prior to transmitting data and the API is configured to receive the communication to determine a type of the data input device.
91. The system of example 90 wherein the API is further configured to receive the data from the data input device and transmit it to the server.
92. The system of example 91 wherein the API is further configured to transform the data received from the data input device before transmitting it to the server, so that data received from multiple types of data input devices is configured to the same format before being stored on the server.
93. The system of example 90 that includes multiple data input devices.
94. The system of example 92 or 93 wherein at least one of the multiple data input devices transmits data in a format different than the format used by the other of the multiple data input devices.
95. The system of any of examples 76-94 that further includes a second server with a memory that receives all of the data except the video data.
96. The system of example 95 wherein the second server stores data in specific individual files corresponding to a specific vehicle to which the data is associated.
97. The system of example 96 wherein the server configures the specific vehicle data to be displayed in one of the following formats:
   (a) chronologically,
   (b) by the entity that performed the repairs, or
   (c) by the type of maintenance or repair performed.
98. The system of any of examples 95-97 wherein data is input into the second server via the data input device wherein the data input device is remote to the server.
99. The system of example 98 that further includes an API in communication with the server wherein the data input device is programmed to send a communication to the API prior to transmitting data and the API is configured to receive the communication to determine a type of the data input device.
100. The system of example 99 that further includes an API in communication with the server wherein the data input device is programmed to send a communication to the API prior to transmitting data and the API is configured to receive the communication to determine a type of the data input device.
101. The system of example 100 wherein the API is further configured to receive the data from the data input device and transmit it to the second server.
102. The system of example 98 that includes multiple data input devices.
103. The system of example 98 or 99 wherein at least one of the multiple data input devices transmits data in a format different than the format used by the other of the multiple data input devices.
104. The system of example 96 wherein each unique file for a specific vehicle also includes unique identification indicia specific to that vehicle.
105. The system of example 104 wherein the unique identification indicia is the vehicle identification number.
106. The system of any of examples 76-94 that further includes at least one receiving device remote from the server.
107. The system of examples 76-94 that further includes at least one service technician interface for transmitting information to the server.
108. The system of example 106 that further includes at least one service technician interface for transmitting information to one or both of the server and the at least one receiving device.
109. The system of example 107 or 108 wherein the information includes one or more of:
   (a) an advertisement,
   (b) a price,
   (c) recommended repair work, and
   (d) contact information such as a phone number, SMS address or email address.
110. The system of any of examples 95-105 that further includes at least one receiving device remote from the server.
111. The system of examples 95-105 that further includes at least one service technician interface for transmitting information to the server.
112. The system of example 111 that further includes at least one service technician interface for transmitting information to one or both of the server and the at least one receiving device.
113. The system of example 111 or 112 wherein the information includes one or more of:
   (a) an advertisement,
   (b) a price,
   (c) recommended repair work, and
   (d) contact information such as a phone number, SMS address or email address.
114. The methods performed, respectively, by each of the systems described in examples 76-113.

Further specific examples of the disclosure include the following.
1. A receiving device being configured to communicate with one or more servers that contains vehicle-specific data including video data, the receiving device being configured to receive the data via email, SMS or other wireless communications protocol.
2. The receiving device of example 1 that includes an operating system and software on the operating system that configures it to communicate with the server.
3. The receiving device of examples 1 or 2 wherein an alert is received when new vehicle-specific data is uploaded to the server.
4. The receiving device of any of examples 1-3 wherein, if the vehicle-specific data includes a recommended service or repair, the recommended service or repair may be accepted by activating an icon or rejected by activating a different icon.
5. The receiving device of any of examples 1-4 wherein in addition to the vehicle-specific data, contact information regarding a vehicle repair shop is provided.
6. The receiving device of any of example 5 wherein the vehicle repair shop information includes one or more of a phone number, an email address and a SMS address.
7. The receiving device of any of examples 1-5 that communicates with the server or an API communicating with the server the type of device the receiving device is.
8. The receiving device of any of examples 1-7 that can locate repair shops based on the type of car.
9. The receiving device of any of examples 1-8 wherein the receiving device can locate repair shops based on location.
10. The receiving device of any of examples 1-9 that can locate repair shops based on the type of repair.
11. The receiving device of any of examples 1-10 that is further configured to take photographs and transmit the photographs to the server to be stored.
12. The receiving device of any of examples 1-10 that is further configured to take video data and transmit the video data to the server to be stored.
13. Each method, respectively, based upon each of the proceeding system claims 1-12.

Other specific examples of the disclosure include:
1. A system for facilitating review of proposed services, the system comprising:
   a network;
   a first device having a provider application, the first device coupled to the network; and
   a second device having a customer application, the second device coupled to the network,
   wherein the provider application allows a user to capture information (e.g., video) documenting proposed services to be provided,
   wherein the customer application displays information (e.g., video) regarding the proposed services, and
   wherein the customer can use the application to contact the user in response to the proposed services.
2. The system of example 1, further comprising a database coupled to the network, wherein the database comprises consumer information.
3. The system of example 2, wherein the system further comprises a web services server and the database forms part of the web services server.
4. The system of example 2, wherein customer information comprises customer contact information.
5. The system of example 2, wherein customer information comprises a vehicle identification number.
6. The system of any of examples 1-5, further comprising a streaming server coupled to the network.
7. The system of example 6, wherein the streaming server comprises a profile page.
8. The system of any of claims 6-7, wherein the streaming server comprises a streaming server application.
9. The system of example 8, wherein the streaming server application determines a communication bandwidth of the network.
10. The system of any of claims 8-9, wherein the streaming server application determines an operating system of the second device.
11. The system of any of claims 8-10, wherein the streaming server application compresses the information documenting proposed services.
12. The system of example 11, wherein the streaming server application further causes the compressed information documenting proposed services to be transmitted to the second device.
13. The system of example 12, wherein the transmission comprises streaming.
14. The system of any of examples 1-13, further comprising a third device comprising a warranty provider application.
15. The system of any of examples 1-14, wherein the customer application sends a notification to the provider application when the customer causes to be displayed information (e.g., video) regarding the proposed services.
16. The system of any of examples 1-15, wherein the provider application sends a coupon to the customer application.
17. The system of any of examples 1-16, wherein the customer application receives a notification when the information documenting proposed services to be provided is ready to be viewed.
18. A method for reviewing proposed services, the method comprising the steps of:
   storing customer information in a database;
   using a first device, capturing information regarding the proposed services;
   streaming the information regarding the proposed services to a streaming server;
   using the streaming server, compressing and/or encoding or transposing the information regarding the proposed services; and
   sending the compressed encoded and/or transposed information regarding the proposed services to a second device.
19. The method of example 18, wherein the step of compressing is performed in real-time.
20. The method of any of examples 18-19, further comprising a step of using the streaming server, determining a type of the second device.
21. The method of any of examples 18-20, wherein the customer information comprises a vehicle identification number.
22. The method of any of examples 18-21, wherein the customer information comprises a history of related services.
23. The method of any of examples 18-22, further comprising a step of sending to the second device a cost estimate of the services.
24. The method of any of examples 18-23, further comprising a step of sending a notification from the second device to the first device, wherein the notice indicates whether a customer has reviewed the compressed information.
25. The method of any of examples 18-24, wherein the step of sending is automatic.
26. The method of any of examples 18-25, further comprising a step of recording (video and/or audio) a conversation with a customer.
27. The method of example 26, wherein the step of recording comprises recording a description of services desired by the customer.
28. The method of any of examples 26-27, wherein the step of recording comprises recording a description of services provided by a service provider.
29. A method of presenting proposed services, the method comprising the steps of:
   providing a first device having a first application;
   providing a second device having a second application;
   providing a steaming server connected to the first device and the second device;
   providing a database connected to the steaming server;
   using the first device, capturing a vehicle identifier;
   storing the vehicle identifier in the database;
   using the first device, streaming electronic information regarding proposed services to the steaming server;
   using the steaming server, compressing the information regarding proposed services; and
   using a network, transmitting the compressed information to the second device.
30. The method of example 29, further comprising a step of storing service provision history on the database.
31. The method of any of examples 29-30, further comprising a step of performing analytics using the customer information.
32. The method of any of examples 29-31, wherein the customer information is associated with one or more of: a name, a vehicle identification number, and a customer identification.
33. The method of any of examples 29-32, further comprising a step of accepting one or more proposed services using one or more of: an email, a phone call, a button displayed by the application.
33.1 The method of any of examples 29-32, further comprising a step of NOT accepting one or more proposed services using one or more of: an email, a phone call, a button displayed by the application.
34. The method any of examples 29-33, further comprising a step of, using the first application, creating a recommend service.
35. The method of example 34, wherein the step of creating a recommended service comprises selecting a service from a list of services.
36. The method of any of examples 34-35, wherein the step of creating a recommended service comprises using speech-to-text to describe the recommended service.
37. The method of any of examples 34-36, wherein the step of creating a recommended service comprises video recording of a part to be repaired or replaced.
38. The method of any of examples 34-37, wherein the step of creating a recommended service further comprises a step of previewing video information.
39. The method of any of examples 34-38, wherein the step of creating a recommended service further comprises locating a separate record for each recommended repair.
40. The method of any of examples 34-39, wherein the step of creating a recommended service further comprises a step of capturing video information to show completed work.
41. The method of example 29, further comprising a step of reviewing the electronic information regarding proposed services.
42. The method of example 41, further comprising a step of discarding reviewed electronic information and performing another step of capturing.
43. The method of any of examples 29-42, wherein a format used during the step of compressing depends on a type of the second device.
44. The method of any of examples 29-43, wherein the second device comprises a device selected from the group consisting of a mobile phone, a tablet, and a computer.
45. The method of any of examples 29-44, wherein the streaming server identifies an operating system of the second device and formats the compressed information according to the operating system.
46. The method of example any of examples 29-45, further comprising a step of using the streaming server, determining a bandwidth of communication between the steaming server and the second device.
47. The method of any of examples 29-46, wherein compressed video comprises high-definition video.
48. The method of any of examples 29-47, wherein the database stores a vehicle identification number and a history of services associated with the vehicle identification number.
49. The method of example 48, wherein the history of services includes electronic video information corresponding to recommended service.
50. The method of any of examples 48-49, wherein the history of service includes information corresponding to completed services.
51. The method of any of examples 29-50, wherein the second application runs in the background on the second device.
52. The method of any of examples 29-51, wherein the database comprises recommended but not yet completed work/services.
53. The method of any of examples 29-52, further comprising a step of displaying a price associated with the service.
54. A system for facilitating review of proposed services, the system comprising:
   a network;
   a first device having a provider application, the first device coupled to the network; and
   a second device having a customer application, the second device coupled to the network,
   wherein the provider application allows a user to capture information (e.g., video) documenting proposed services to be provided,
   wherein the customer application displays information (e.g., video) regarding the proposed services, and
   wherein the customer can use the application to contact the user in response to the proposed services.

Other specific examples of the disclosure include:
1. A receiving device being configured to communicate with one or more servers that contains vehicle-specific data including video data, the receiving device being configured to receive the data via email, SMS or other wireless communications protocol.
2. The receiving device of example 1 that includes an operating system and software on the operating system that configures it to communicate with the server.
3. The receiving device of examples 1 or 2 wherein an alert is received when new vehicle-specific data is uploaded to the server.
4. The receiving device of any of examples 1-3 wherein, if the vehicle-specific data includes a recommended service or repair, the recommended service or repair may be accepted by activating an icon or rejected by activating a different icon.
5. The receiving device of any of examples 1-4 wherein in addition to the vehicle-specific data, contact information regarding a vehicle repair shop is provided.
6. The receiving device of any of example 5 wherein the vehicle repair shop information includes one or more of a phone number, an email address and a SMS address.
7. The receiving device of any of examples 1-5 that communicates with the server or an API communicating with the server the type of device the receiving device is.
8. The receiving device of any of examples 1-7 that can locate repair shops based on the type of car.
9. The receiving device of any of examples 1-8 wherein the receiving device can locate repair shops based on location.
10. The receiving device of any of examples 1-9 that can locate repair shops based on the type of repair.
11. The receiving device of any of examples 1-10 that is further configured to take photographs and transmit the photographs to the server to be stored.
12. The receiving device of any of examples 1-10 that is further configured to take video data and transmit the video data to the server to be stored.
13. Each method, respectively, based upon each of the proceeding system claims 1-12.

Other specific examples of the disclosure include:
1. A system for creating a vehicle file, the system comprising:
   one or more data input devices, the one or more data input devices programmed to record and transmit video data regarding a vehicle;
   a server for receiving and storing the video data from the one or more data input devices; and
   a receiving device configured for receiving the video data from the server by entering security information via the device, the security information for transmission to the server to establish that the device is authorized to receive the video data.
2. The system of example 1 wherein the server transmits the video file to the receiving device.
3. The system of example 1 or 2 that further includes an API that transmits the video data to the receiving device.
4. The system of example 1 wherein the receiving device is one of the group consisting of: a lap top computer, a desk top computer, a cellular phone, and a tablet.
5. The system of any of examples 1-4 wherein the receiving device is a portable electronic device.
6. The system of example 1 wherein the one or more data input devices is a tablet.
7. The system of any of examples 1-6 wherein the one or more data input devices is wireless.
8. The system of any of examples 1-6 wherein the one or more data input devices transmits the video data wirelessly.
9. The system of any of examples 1-8 wherein the server compresses the video data.
10. The system of any of examples 1-8 wherein the serves stores the video data in a discrete file.
11. The system of example 10 wherein the discrete file is associated with a specific vehicle.
12. The system of example 11 wherein the discrete file is identified by a vehicle identification number.
13. The system of example 3 wherein the API verifies a type of the receiving device.
14. The system of example 13 wherein the API formats the video data based on the type of receiving device.
15. The system of example 14 wherein the formatting of the video data includes compression of the video data.
16. The system of any of examples 1-15 wherein the video data is displayed on the data input device as it is recorded.
17. The system of any of examples 1-16 wherein the receiving device includes an operating system and software on the operating system, the software programmed to receive the video data from the server.
18. The system of example 17 wherein the receiving device has a screen and the software is operable to display a homepage on the screen, the homepage including a window for receiving the security information to be transmitted to the server.
19. The system of example 18 wherein the device has keys for inputting information, including the security information.
20. The system of example 18 or 19 wherein the software can store the security information.
21. The system of any of examples 1-19 wherein there is a single data input device.
22. The system of any of examples 1-20 wherein there are multiple data input devices.
23. The system of any of examples 1-20 or 22 wherein the one or more data input devices stores the video data.
24. The system of example 22 wherein the single data input device stores the video data.
25. The system of example 23 wherein the one or more data input devices stores the video data temporarily.
26. The system of any of examples 1-20, 22 or 25 wherein the one or more data input devices displays the video data while the video data is recorded.
27. The system of any of examples 1-20, 22, or 25-26 wherein the one or more data input devices transmits the video data to the server after the video data is recorded.
28. The system of any of examples 1-27 wherein the video data can be erased from the one or more data input devices after being transmitted.

Other specific examples of the disclosure include:
1. A system for creating a vehicle file, the system comprising:
   (a) one or more data input devices, the one or more data input devices programmed to record and transmit video data regarding a vehicle;
   (b) a server for receiving and storing the video data from the one or more data input devices; and
   (c) a receiving device configured for receiving the video data from the server by entering security information via the device, the security information for transmission to the server to establish that the device is authorized to receive the video data.
2. The system of example 1 wherein the one or more data input devices are further programmed to record audio data and transmit the audio data to the server, and the receiving device is further configured to receive the audio data from the server.
3. The system of example 2 wherein the server transmits the audio file to the receiving device.
4. The system of any of examples 2-3 wherein the server compresses the audio data.
5. The system of any of examples 2-4 wherein the server stores the audio data in a discrete file.
6. The system of any of examples 1-5 wherein the audio data is played on the data input device as it is being recorded.
7. The system of any of examples 1-6 wherein the receiving device includes an operating system and software on the operating system, the software for receiving the audio data from the server.
8. The system of any of examples 1-7 wherein each data input device stores the audio file.
9. The system of example 8 wherein each data input device stores the audio file temporarily.
10. The system of any of examples 1-8 wherein each data input device transmits the audio data after the audio data is recorded.
11. The system of any of examples 1-9 wherein the audio data can be erased from each data input device after being transmitted to the server.
12. The system of example 10 wherein the one or more data input devices store the video data temporarily.
13. The system of example 12 wherein the one or more data input devices store the video data at least until the video data is transmitted to the server.
14. The system of example 1, 10, or 12 wherein the one or more data input devices transmit the video data to the server after the video data is recorded.
15. The system of example, 1, 10, or 12 wherein the one or more data input devices display the video data while it is being recorded.
16. The system of any of examples 2-15 wherein the server stores the video data and a second server stores the audio data.
17. The system of example 16 wherein the video data in the server is stored in a first discrete file and the audio data in the second server is stores in a second discrete file corresponding to the first discrete file.
18. The system of example 17 wherein the first discrete file is associated with a specific vehicle and the second discrete file is associated with the specific vehicle.
19. The system of example 17 or 18 wherein the first discrete file and the second discrete file are identifiable by a vehicle identifier.
20. The system of example 19 wherein the vehicle identifier is vehicle identification number.
21. The system of any of examples 17-20 wherein the receiving device is configured to receive the video data from the server and the audio data from the second server.
22. The system of example 21 wherein the receiving device simultaneously receives video data from the server and audio data from the second server.
23. The system of any of examples 1-23 wherein the video data relates to suggested repairs or maintenance for a vehicle.
24. The system of example 23 wherein the video data also relates to repairs or maintenance performed on a vehicle.
25. The system of any of examples 1-24 wherein the audio data relates to suggested repairs or maintenance for a vehicle.
26. The system of example 25 wherein the audio data also relates to repairs or maintenance performed on a vehicle.
27. The system of any of examples 1-26 wherein the receiving device is configured to send an authorization to the server for the server to send data to the receiving device.
28. The system of any of examples 16-27 wherein the receiving device is configured to send an authorization to the server or to the second server for the server to send data to the receiving device.
29. The system of any of examples 1-28 wherein the video data is transmitted to the receiving device in a SMS message or an email.
30. The system of any of examples 1-29 wherein the audio data is transmitted to the receiving device in a SMS message or an email.
31. The system of any of examples 29-30 wherein the authorization is sent wirelessly.
32. The system of any of examples 30-31 wherein the video data and/or audio data are transmitted wirelessly.
33. The system of any of examples 1-32 wherein the server includes multiple files of video data regarding a specific vehicle.
34. The system of any of examples 1-21 wherein the server or second server includes multiple files of audio data regarding a specific vehicle.
35. The system of example 28-34 wherein the multiple files of video data can be accessed by accessing the file for the specific vehicle.
36. The system of example 35 wherein the multiple files of audio data can be accessed by accessing the file for the specific vehicle.
37. The system of example 34 wherein the multiple video files include one or more of:
   (a) a history of repairs or maintenance suggested for the specific vehicle,
   (b) a history of repairs or maintenance performed on the specific vehicle, and
   (c) a history of an owner of the specific vehicle accepting or rejecting suggested repairs or maintenance.
38. The system of example 34 wherein the multiple audio files include one or more of:
   (a) a history of repairs or maintenance suggested for the specific vehicle,
   (b) a history of repairs or maintenance performed on the specific vehicle, and
   (c) a history of an owner of the specific vehicle accepting or rejecting suggested repairs or maintenance.
39. The system of example 34 wherein the server or second server includes multiple files of audio data regarding a specific vehicle and the server includes multiple files of video data regarding a specific vehicle, wherein each file of audio data corresponds to a file of video data.
40. The system of example 34 wherein upon a request from the receiving device at least on file of audio data and the file of video data that corresponds to the file of audio data is transmitted to the receiving device by either the server, the server and the second server, or the API and the second server.
41. The system of any of examples 1-40 wherein there is an interface for a service technical to access information from the server.
42. The system of any of examples 1-21 wherein there is an interface for a service technician to access information from the second server.
43. The system of example 42 wherein the service technician can add one or more of the following to the video file or the audio file:
   (a) a price for suggested repair or maintenance,
   (b) an advertisement,
   (c) a discount coupon for parts or services,
   (d) offers for other repairs or maintenance,
   (e) a phone number, email address or SMS address for the vehicle owner to contact the service technician.
44. The system of any of examples 1-43 wherein data retrieved by the receiving device from one or both of the server or the second server (if utilized) includes one or more of:
   (a) a price for suggested repair or maintenance,
   (b) an advertisement,
   (c) a discount coupon for parts or services,
   (d) offers for other repairs or maintenance,
   (e) a phone number, email address or SMS address for the vehicle owner to contact the service technician.
45. The system of any of example 1-44 wherein software is downloaded onto the receiving device prior to the receiving device being capable of receiving data from the server or second server (if utilized).
46. The system of any of examples 1-44 wherein data transmitted to the receiving device includes one or more of a phone number, email address or SMS address to contact a vehicle repair center that created the video data and (if utilized) the audio data.
47. The methods as performed, respectively, by each of system examples 1-46.

Other specific examples of the disclosure include:
1. A system for facilitating vehicle maintenance, the system comprising:
   a server having a memory and being programmed to compress and store video files, and further having at least one user interface for receiving data from a user, the data including video data, the memory configured to store data received by the user for a specific vehicle in a file for that specific vehicle, wherein the file for each specific vehicle includes identification indicia unique to that vehicle.
2. The system of example 1 wherein the identification indicia is the vehicle identification number.
3. The system of example 1 or 2 wherein the data further includes one or more of: audio data, text, advertisements, prices, and contact information.
4. The system of any of examples 1-3 wherein the video data is received wirelessly from a remote source and the server has an API programmed to receive the video data and enter it into the server.
5. The system of example 4 wherein the data is received wirelessly from a remote source and the server has an API programmed to receive the video data and enter it into the server.
6. The system of any of examples 1-5 wherein the file for each specific vehicle includes data entered at different dates and times for the specific vehicle.
7. The system of example 6 wherein each data entered at a different date and time includes the date and time the data was created.
8. The system of example 7 wherein each data entered at a different time is stored in a subfile within the specific vehicle file.
9. The system of any of examples 1-8 wherein the data can be retrieved from the server.
10. The system of any of examples 1-8 wherein the video data includes one or more of:
   (a) images of a vehicle before it enters a repair shop,
   (b) images of a vehicle showing one or more areas that require repair,
   (c) images of a vehicle showing repair work being performed, and
   (d) images of a vehicle after repair work is completed.
11. The system of example 9 wherein a specific vehicle file can be retrieved using the identification indicia unique for that vehicle.
12. The system of example 11 wherein specific vehicle data can be retrieved by using the identification indicia unique for that vehicle and the date and time associated with the data.
13. The system of example 9, 11, or 12 wherein the server configures the specific vehicle data to be displayed in one of the following formats:
   (a) chronologically,
   (b) by the entity that performed the repairs, or
   (c) by the type of maintenance or repair performed.
14. The system of any of examples 1-3 wherein the system further includes a data input device configured to input the data into the server wherein the data input device is remote to the server.
15. The system of example 14 that further includes an API in communication with the server wherein the data input device is programmed to send a communication to the API prior to transmitting data and the API is configured to receive the communication to determine a type of the data input device.
16. The system of example 15 wherein the API is further configured to receive the data from the data input device and transmit it to the server.
17. The system of example 16 wherein the API is further configured to transform the data received from the data input device before transmitting it to the server, so that data received from multiple types of data input devices is configured to the same format before being stored on the server.
18. The system of example 15 or 16 that includes multiple data input devices.
19. The system of example 17 or 18 wherein at least one of the multiple data input devices transmits data in a format different than the format used by the other of the multiple data input devices.
20. The system of any of examples 1-19 that further includes a second server with a memory that receives all of the data except the video data.
21. The system of example 20 wherein the second server stores data in specific individual files corresponding to a specific vehicle to which the data is associated.
22. The system of example 21 wherein the server configures the specific vehicle data to be displayed in one of the following formats:
   (a) chronologically,
   (b) by the entity that performed the repairs, or
   (c) by the type of maintenance or repair performed.
23. The system of any of examples 20-22 wherein data is input into the second server via the data input device wherein the data input device is remote to the server.
24. The system of example 23 that further includes an API in communication with the server wherein the data input device is programmed to send a communication to the API prior to transmitting data and the API is configured to receive the communication to determine a type of the data input device.
25. The system of example 25 that further includes an API in communication with the server wherein the data input device is programmed to send a communication to the API prior to transmitting data and the API is configured to receive the communication to determine a type of the data input device.
26. The system of example 25 wherein the API is further configured to receive the data from the data input device and transmit it to the second server.
27. The system of example 23 that includes multiple data input devices.
28. The system of example 23 or 24 wherein at least one of the multiple data input devices transmits data in a format different than the format used by the other of the multiple data input devices.
29. The system of example 25 wherein each unique file for a specific vehicle also includes unique identification indicia specific to that vehicle.
30. The system of example 29 wherein the unique identification indicia is the vehicle identification number.
31. The system of any of examples 1-30 that further includes at least one receiving device remote from the server.
32. The system of examples 1-30 that further includes at least one service technician interface for transmitting information to the server.
33. The system of example 32 that further includes at least one service technician interface for transmitting information to one or both of the server and the at least one receiving device.
34. The system of example 32 or 33 wherein the information includes one or more of:
   (a) an advertisement,
   (b) a price,
   (c) recommended repair work, and
   (d) contact information such as a phone number, SMS address or email address.
35. The system of any of examples 1-34 that further includes at least one receiving device remote from the server.
36. The system of example 35 that further includes at least one service technician interface for transmitting information to one or both of the server and the at least one receiving device.
37. The system of example 36 wherein the information includes one or more of:
   (a) an advertisement,
   (b) a price,
   (c) recommended repair work, and
   (d) contact information such as a phone number, SMS address or email address.
38. The methods performed, respectively, by each of the systems described in examples 1-37.

What is claimed is:

1. A system for facilitating vehicle maintenance, the system comprising:
a server having a memory and being programmed to compress and store video files, and further having at least one user interface for receiving data from a user, the data including video data, the memory configured to store data received by the user for a specific vehicle in a file for that specific vehicle, wherein the file for each specific vehicle includes identification indicia unique to that vehicle.

2. The system of claim 1, wherein the identification indicia is the vehicle identification number.

3. The system of claim 1, wherein the data further includes one or more of: audio data, text, advertisements, prices, and contact information.

4. The system of claim 1, wherein the video data is received wirelessly from a remote source and the server has an API programmed to receive the video data and enter it into the server.

5. The system of claim 4, wherein the data is received wirelessly from a remote source and the server has an API programmed to receive the video data and enter it into the server.

6. The system of claim 1, wherein the file for each specific vehicle includes data entered at different dates and times for the specific vehicle.

7. The system of claim 6, wherein each data entered at a different date and time includes the date and time the data was created.

8. The system of claim 7, wherein each data entered at a different time is stored in a subfile within the specific vehicle file.

9. The system of claim 1, wherein the data can be retrieved from the server.

10. The system of claim 1, wherein the video data includes one or more of:
(a) images of a vehicle before it enters a repair shop,
(b) images of a vehicle showing one or more areas that require repair,
(c) images of a vehicle showing repair work being performed, and
(d) images of a vehicle after repair work is completed.

11. The system of claim 9, wherein a specific vehicle file can be retrieved using the identification indicia unique for that vehicle.

12. The system of claim 11, wherein specific vehicle data can be retrieved by using the identification indicia unique for that vehicle and the date and time associated with the data.

13. The system of claim 9, wherein the server configures the specific vehicle data to be displayed in one of the following formats:
(a) chronologically,
(b) by the entity that performed the repairs, or
(c) by the type of maintenance or repair performed.

14. The system of claim 1, wherein the system further includes a data input device configured to input the data into the server wherein the data input device is remote to the server.

15. The system of claim 14, that further includes an API in communication with the server wherein the data input device is programmed to send a communication to the API prior to transmitting data and the API is configured to receive the communication to determine a type of the data input device.

16. The system of claim 15, wherein the API is further configured to receive the data from the data input device and transmit it to the server.

17. The system of claim 16, wherein the API is further configured to transform the data received from the data input device before transmitting it to the server, so that data received from multiple types of data input devices is configured to the same format before being stored on the server.

18. The system of claim 15 that includes multiple data input devices.

19. The system of claim 18, wherein at least one of the multiple data input devices transmits data in a format different than the format used by the other of the multiple data input devices.

20. The system of claim 1 that further includes a second server with a memory that receives all of the data except the video data.
